(19) United States
(12) Patent Application Publication
(10) Pub. No.: US 2026/0006312 A1
(43) Pub. Date: Jan. 1, 2026

(54) CONTROL APPARATUS AND METHOD, IMAGE CAPTURING APPARATUS AND CONTROL METHOD THEREOF, SYSTEM, AND STORAGE MEDIUM

(71) Applicant: CANON KABUSHIKI KAISHA, Tokyo (JP)

(72) Inventors: YOHEI SHOGAKI, Kanagawa (JP); GENKI CHO, Kanagawa (JP)

(21) Appl. No.: 19/245,024

(22) Filed: Jun. 20, 2025

(30) Foreign Application Priority Data
Jun. 28, 2024 (JP) 2024-105478

(51) Int. Cl. H04N 23/63; H04N 23/65; H04N 23/661; H04N 23/667

(52) U.S. Cl. CPC H04N 23/631; H04N 23/633; H04N 23/65; H04N 23/661; H04N 23/667

(57) ABSTRACT

A control apparatus obtains first ID of a camera connected via a network, and information obtained by the camera and related to second ID of at least one of a terminal apparatus that exhibits information on a patient and an application activated on the terminal apparatus and for viewing the information on the patient; obtains, from a management apparatus of the patient, the information on the patient corresponding to the second ID; stores first and second IDs in association with each other; and in a case where the information on the patient being exhibited on the terminal apparatus corresponding to the second ID has been changed, performs control to transmit, to the camera associated with the second ID, the information on the patient corresponding to the second ID that has been newly obtained from the management apparatus.

### BACKGROUND

### Field of the Technology

The present disclosure relates to a control apparatus and a method, an image capturing apparatus and a control method thereof, a system, and a storage medium, and particularly to control at the time of capturing an image of a management target in a medical site or the like.

### Description of the Related Art

There are medical systems and image capturing apparatuses that capture images, record captured data, and assist in organization and classification. Such image capturing apparatuses use patient-specific identification information, or transmit identification information to an external apparatus, receive various kinds of information associated with the identification information from the external apparatus, and use it to obtain necessary patient information from a medical system via a communication medium. Japanese Patent Laid-Open No. 2014-11689 discloses requesting from a server apparatus information related to a person associated with a person included in an image captured by a camera and displaying on the image the information related to the person obtained from the server apparatus.

However, in the technique described in Japanese Patent Laid-Open No. 2014-11689, since information related to a person is obtained based on physical position information, when capturing images of a plurality of different people at the same location, a user needs to appropriately operate the camera, which requires effort.

### SUMMARY

The present disclosure has been made in consideration of the above situation, and reduces effort required from a user for an image capturing apparatus to obtain information on a person at the time of capturing images of a plurality of different people.

According to the present disclosure, provided is a control apparatus comprising one or more processors which function as: a first obtaining unit that obtains, from an image capturing apparatus connected via a communication unit, first identification information of the image capturing apparatus, and information obtained by the image capturing apparatus and related to second identification information of at least one of a terminal apparatus on which information on a management target can be viewed and an application activated on the terminal apparatus and for viewing the information on the management target; a second obtaining unit that obtains, from a management apparatus of the management target via the communication unit, the information on the management target corresponding to the second identification information; a storage unit that stores first identification information and the second identification information in association with each other; and a control unit that, in a case where the information on the management target being viewed in the terminal apparatus corresponding to the second identification information has been changed, performs control so as to transmit, to the image capturing apparatus associated with the second identification information, the information on the management target corresponding to the second identification information that has been newly obtained from the management apparatus.

Further, according to the present disclosure, provided is an image capturing apparatus comprising: an image capturing unit that captures an image; and one or more processors which function as: an obtaining unit that obtains information related to first identification information of at least one of a terminal apparatus on which information on a management target can be viewed and an application activated on the terminal apparatus and for viewing information on a management target; a transmission unit that transmits, to a control apparatus connected via a communication unit, the information related to the first identification information and second identification information of the image capturing apparatus; a reception unit that receives, from the control apparatus, information on a management target corresponding to the first identification information; and a processing unit that attaches the information on the management target to image data of the image captured by the image capturing unit.

Furthermore, according to the present disclosure, provided is a system comprising: a control apparatus comprising one or more processors which function as: a first obtaining unit that obtains, from an image capturing apparatus connected via a communication unit, first identification information of the image capturing apparatus, and information obtained by the image capturing apparatus and related to second identification information of at least one of a terminal apparatus on which information on a management target can be viewed and an application activated on the terminal apparatus and for viewing the information on the management target; a second obtaining unit that obtains, from a management apparatus of the management target via the communication unit, the information on the management target corresponding to the second identification information; a storage unit that stores first identification information and the second identification information in association with each other; and a control unit that, in a case where the information on the management target being viewed in the terminal apparatus corresponding to the second identification information has been changed, performs control so as to transmit, to the image capturing apparatus associated with the second identification information, the information on the management target corresponding to the second identification information that has been newly obtained from the management apparatus, an image capturing apparatus comprising: an image capturing unit that captures an image; and one or more processors which function as: an obtaining unit that obtains information related to first identification information of at least one of a terminal apparatus on which information on a management target can be viewed and an application activated on the terminal apparatus and for viewing information on a management target; a transmission unit that transmits, to a control apparatus connected via a communication unit, the information related to the first identification information and second identification information of the image capturing apparatus; a reception unit that receives, from the control apparatus, information on a management target corresponding to the first identification information; and a processing unit that attaches the information on the management target to image data of the image captured by the image capturing unit, the terminal apparatus; and the management apparatus.

Further, according to the present disclosure, provided is a control method comprising: obtaining, from an image capturing apparatus connected via a communication unit, first identification information of the image capturing apparatus, and information obtained by the image capturing apparatus and related to second identification information of at least one of a terminal apparatus on which information on a management target can be viewed and an application activated on the terminal apparatus and for viewing the information on the management target; obtaining, from a management apparatus of a management target via the communication unit, information on the management target corresponding to the second identification information; storing first identification information and the second identification information in association with each other; and in a case where the information on the management target being viewed in the terminal apparatus corresponding to the second identification information has been changed, transmitting, to the image capturing apparatus associated with the second identification information, the information on the management target corresponding to the second identification information that has been newly obtained from the management apparatus.

Further, according to the present disclosure, provided is a method of controlling an image capturing apparatus, the method comprising: obtaining information related to first identification information of at least one of a terminal apparatus on which information on a management target can be viewed and an application activated on the terminal apparatus and for viewing information on a management target; transmitting, to a control apparatus connected via a communication unit, the information related to the first identification information and second identification information of the image capturing apparatus; receiving, from the control apparatus, information on a management target corresponding to the first identification information; and attaching the information on the management target to image data of the image captured by the image capturing unit.

Further, according to the present disclosure, provided is an image capturing apparatus comprising: an image capturing unit that captures an image; and one or more processors which function as: an obtaining unit that obtains mode information; a switching unit, based on the mode information, that switches between a first mode in which first identification information indicating a management target is transmitted to a control apparatus and a second mode in which second identification information indicating at least one of a terminal apparatus on which information on the management target can be viewed and an application activated on the terminal apparatus and for viewing the information on the management target is transmitted to the control apparatus; a transmission unit, in a case of the first mode, that transmits the first identification information to a control apparatus connected via a communication unit and, in a case of the second mode, transmits the second identification information to the control apparatus; a reception unit receives, from the control apparatus, information on a management target corresponding to the first identification information or the second identification information; and a processing unit that attaches the information on the management target to image data of the image captured by the image capturing unit.

Further, according to the present disclosure, provided is a method of controlling an image capturing apparatus obtaining mode information; based on the mode information, switching between a first mode in which first identification information indicating a management target is transmitted to a control apparatus and a second mode in which second identification information indicating at least one of a terminal apparatus on which information on the management target can be viewed and an application activated on the terminal apparatus and for viewing the information on the management target is transmitted to the control apparatus; in a case of the first mode, transmitting the first identification information to a control apparatus connected via a communication unit and, in a case of the second mode, transmitting the second identification information to the control apparatus; receiving, from the control apparatus, information on a management target corresponding to the first identification information or the second identification information; and attaching the information on the management target to image data of the image captured by the image capturing unit.

Further, according to the present disclosure, provided is a non-transitory computer-readable storage medium storing a program that causes a computer to function as each unit of the control apparatus comprising one or more processors which function as: a first obtaining unit that obtains, from an image capturing apparatus connected via a communication unit, first identification information of the image capturing apparatus, and information obtained by the image capturing apparatus and related to second identification information of at least one of a terminal apparatus on which information on a management target can be viewed and an application activated on the terminal apparatus and for viewing the information on the management target; a second obtaining unit that obtains, from a management apparatus of the management target via the communication unit, the information on the management target corresponding to the second identification information; a storage unit that stores first identification information and the second identification information in association with each other; and a control unit that, in a case where the information on the management target being viewed in the terminal apparatus corresponding to the second identification information has been changed, performs control so as to transmit, to the image capturing apparatus associated with the second identification information, the information on the management target corresponding to the second identification information that has been newly obtained from the management apparatus.

Further, according to the present disclosure, provided is a non-transitory computer-readable storage medium storing a program that causes a computer to function as each unit of the image capturing apparatus comprising: an obtaining unit that obtains information related to first identification information of at least one of a terminal apparatus on which information on a management target can be viewed and an application activated on the terminal apparatus and for viewing information on a management target; a transmission unit that transmits, to a control apparatus connected via a communication unit, the information related to the first identification information and second identification information of an image capturing apparatus; a reception unit that receives, from the control apparatus, information on a management target corresponding to the first identification information; and a processing unit that attaches the information on the management target to image data of an image captured by an image capturing unit provided within the image capturing apparatus.

Further, according to the present disclosure, provided is a non-transitory computer-readable storage medium storing a program that causes a computer to function as each unit of the image capturing apparatus one or more processors which function as: an obtaining unit that obtains mode information; a switching unit, based on the mode information, that switches between a first mode in which first identification information indicating a management target is transmitted to a control apparatus and a second mode in which second identification information indicating at least one of a terminal apparatus on which information on the management target can be viewed and an application activated on the terminal apparatus and for viewing the information on the management target is transmitted to the control apparatus; a transmission unit, in a case of the first mode, that transmits the first identification information to a control apparatus connected via a communication unit and, in a case of the second mode, transmits the second identification information to the control apparatus; a reception unit receives, from the control apparatus, information on a management target corresponding to the first identification information or the second identification information; and a processing unit that attaches the information on the management target to image data of an image captured by an image capturing unit provided within the image capturing apparatus.

Features of the present disclosure will become apparent from the following description of embodiments with reference to the attached drawings. The following description of embodiments are described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a diagram illustrating an example of a configuration of an image capturing system according to an embodiment of the present disclosure.

FIG. 2A is a block diagram illustrating an example of a hardware configuration of the image capturing apparatus according to the present embodiment.

FIG. 2B is a diagram of the appearance of the image capturing apparatus according to the present embodiment.

FIG. 3 is a block diagram illustrating an example of a hardware configuration of an image capturing control apparatus according to the present embodiment.

FIG. 4 is a block diagram illustrating an example of a hardware configuration of an electronic medical record terminal apparatus according to the present embodiment.

FIG. 5 is a conceptual diagram for when the image capturing control apparatus is operated by virtualization according to the present embodiment.

FIG. 6 is a flowchart for explaining processing in the image capturing apparatus according to a first embodiment.

FIGS. 7A to 7D are diagrams illustrating examples of graphical user interfaces to be displayed on a display of the image capturing apparatus according to the first embodiment.

FIGS. 8A and 8B are diagrams illustrating examples of guidance screens at the time of capturing an image of an ID code according to the first embodiment.

FIGS. 9A and 9B are diagrams illustrating examples of an ID code of the electronic medical record terminal apparatus and an ID code of an electronic medical record application according to the first embodiment.

FIG. 10 is a flowchart for explaining pairing management processing according to the first embodiment.

FIG. 11A is a diagram illustrating an example of a list of camera IDs and terminal/application IDs according to the first embodiment.

FIG. 11B is a diagram illustrating an example of pairing information according to the first embodiment.

FIG. 12 is a flowchart for explaining image capturing processing according to the first embodiment.

FIGS. 13A and 13B are diagrams illustrating examples of GUIs at the time of transmitting captured data according to the first embodiment.

FIG. 14 is a diagram illustrating an example of a GUI at the time of capturing an image of a two-dimensional code according to a second embodiment.

FIG. 15 is a diagram illustrating an example of a screen during pairing processing according to the second embodiment.

FIG. 16 is a diagram illustrating an example of a standby screen according to the second embodiment.

FIG. 17 is a diagram illustrating an example of an electronic medical record communication confirmation screen according to the second embodiment.

FIGS. 18A and 18B is a flowchart for explaining image capturing processing according to the second embodiment.

FIGS. 19A and 19B is a flowchart for explaining image capturing processing according to a third embodiment.

### DESCRIPTION OF THE EMBODIMENTS

Hereinafter, embodiments will be described in detail with reference to the attached drawings. Note, the following embodiments are not intended to limit the scope of the claimed disclosure. Multiple features are described in the embodiments, but limitation is not made to an disclosure that requires all such features, and multiple such features may be combined as appropriate. Furthermore, in the attached drawings, the same reference numerals are given to the same or similar configurations, and redundant description thereof is omitted.

### First Embodiment

In a first embodiment, a medical system in which an image capturing apparatus that captures an affected part of a patient in a medical site and assists in diagnosis is used will be described.

Description will be given assuming that, at the time of image capturing, an image of an affected part, such as a patient's skin, is captured using an image capturing apparatus (digital camera) capable of capturing visible light. However, the present disclosure is applicable to cases where information obtained by capturing an image and the form of the camera are different, such as cases of a multi-spectral camera capable of capturing different wavelength ranges depending on the purpose of examination, the purpose of image capturing, and the like, a polarization camera which includes a polarizer which only transmits light vibrating in a specific direction, an infrared camera capable of capturing an infrared to near-infrared range, a three-dimensional shape measurement camera capable of capturing an image of a three-dimensional shape, a microscope-type camera, a dermoscope-type camera, a camera capable of capturing a non-visible light wavelength range, and a camera that includes a plurality of above image capturing functions.

### [Apparatus Configuration of System]

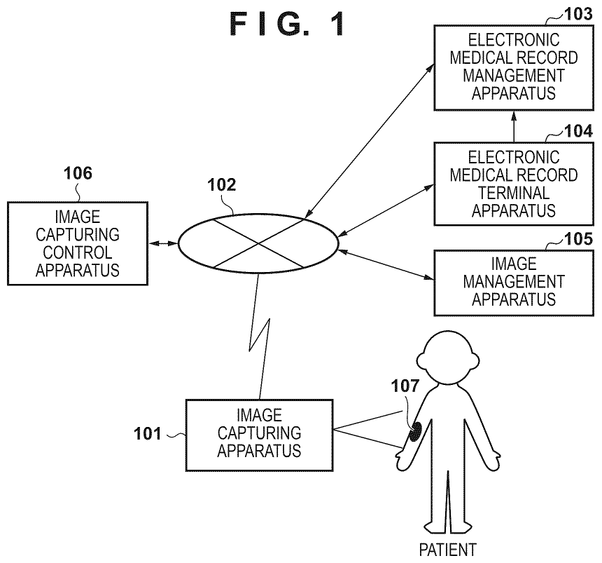

FIG. 1 is a diagram illustrating an example of a configuration of a medical system according to the present embodiment. The medical system according to the present embodiment will be described as being used in a hospital and the like.

In FIG. 1, an image capturing apparatus 101 captures an image of a subject and generates image data. Here, an example in which an image of an affected part 107 of a patient is captured is illustrated. The image capturing apparatus 101 is a small portable image capturing apparatus, similarly to a commercially available digital camera, and is provided with interfaces, such as a display device with which captured images can be confirmed and buttons and a touch panel for various operations. The image capturing apparatus 101 may be configured as a camera used exclusively in the medical system according to the present embodiment, or an application for the present medical system (e.g., a program for medical image capturing) may be stored and executed in a general-purpose camera.

A network 102 realizes communication between apparatuses. For example, when power is turned on by a photographer, the image capturing apparatus 101 connects to the network 102, which will be described later, and can communicate with other apparatuses in the medical system via the network 102. The network 102 is a communication medium and can perform wireless data transmission, wired data transmission, various kinds of control, and the like via the network 102. Various communication protocols, such as Hypertext Transfer Protocol (HTTP), File Transfer Protocol (FTP), Picture Transfer Protocol (PTP), Universal Serial Bus (USB), Local Area Network (LAN), Wireless Fidelity (Wi-Fi®), Health Level Seven (HL7)®, Digital Imaging and Communications in Medicine (DICOM®), Bluetooth (BLE)®, Radio Frequency Identification (RFID), Fast Healthcare Interoperability Resources (FHIR)®, Socket®, and WebSocket, for example, are conceivable as communication protocols to be used, but any may be used so long as image data, text, control data, and the like can be communicated. Further, depending on the standard of the communication medium, it may be possible to control charging of the image capturing apparatus 101, such as wired power supply and wireless power supply, in conjunction with communication.

In the present embodiment, unless otherwise described, the image capturing apparatus 101 and its peripheral apparatuses maintain a state in which communication can be continued until power is turned off. Further, during communication, some of the functions unique to the image capturing apparatus 101 are limited.

Although a connection/communication method related to the image capturing apparatus 101 and the network 102 has been described in detail, the method of connection/communication between various apparatuses, such as an electronic medical record management apparatus 103, an electronic medical record terminal apparatus 104, an image management apparatus 105, and an image capturing control apparatus 106, is similar. Further, although omitted in FIG. 1, lighting and illumination apparatuses configured to emit a range of wavelengths of visible light, such as halogen lighting or light-emitting diode lighting, or a range of wavelengths of non-visible light, such as X-rays or ultraviolet rays, may also be provided for image capturing as necessary. The above respective units communicate and perform control via the network 102 and interfaces provided in the image capturing apparatus 101.

The electronic medical record management apparatus 103 stores patient information (ID, name, medical department, age, date of birth, sex, medical history, history of past treatments, etc.) and doctor information (ID, name, affiliation information such as medical department, etc.) (information on a management target) in the hospital. The electronic medical record management apparatus 103 verifies and authenticates a doctor's login/logoff information with the electronic medical record terminal apparatus 104, provides doctor information, and provides patient information in the form of an electronic medical record. Further, the electronic medical record management apparatus 103 updates data and stores the updated data. Further, the electronic medical record management apparatus 103 may store, for each medical department or for each piece of doctor information, setting information such as image capturing settings of the image capturing apparatus 101. Such an electronic medical record management apparatus 103 is provided as a server on a cloud or in the hospital by using a computer and can be accessed as necessary via the network 102. A plurality of electronic medical record management apparatuses 103 may be configured for each medical department in the hospital.

The electronic medical record terminal apparatus 104 provides an electronic medical record function by transmitting and receiving information on a doctor/staff member who is logged in and information on a patient to be examined to and from the above electronic medical record management apparatus 103 at the time of examination. Doctors and staff can use the electronic medical record function to, for example, display, edit, and update, electronic medical records. The electronic medical record terminal apparatus 104 and the electronic medical record management apparatus 103 may communicate via the network 102 or may communicate directly via wired communication or wireless communication, such as infrared communication or Bluetooth.

The image management apparatus 105 stores, updates, or deletes image data and metadata associated with the image data, such as patient information and photographer information, and references data as necessary. The image management apparatus 105 may be provided for each medical department in the hospital, provided as a server on an external network 102, such as one on a cloud, or provided as a shared storage. Further, the image management apparatus 105 may reference and duplicate necessary information stored in the electronic medical record management apparatus 103 and disclose that data to related apparatuses as appropriate, thereby reducing the load on the electronic medical record management apparatus 103 and increasing confidentiality.

The image capturing control apparatus 106 transmits the above patient information, photographer information, control information, and the like to the image capturing apparatus 101 from various apparatuses constituting the system, such as the electronic medical record terminal apparatus 104, the electronic medical record management apparatus 103, and the image management apparatus 105 which duplicates or holds their information as appropriate, and obtains a usage state of the electronic medical record terminal apparatus 104. Further, even when there are a plurality of image capturing apparatuses 101, electronic medical record management apparatuses 103, electronic medical record terminal apparatuses 104, and image management apparatuses 105, the image capturing control apparatus 106 can manage them by obtaining, recording, and monitoring their dynamic state changes in real time. A state change (usage state) is a variety of states, such as login/logoff information states of doctors, staff, and the like, an editing state at the time of data update, and an update storage state of updated data, for example.

Further, the image capturing control apparatus 106 is connected to a data server, a control management system, and the like in the hospital via the network 102 so as to be capable of communication and can transmit and receive various kinds of management information, setting information, information updates, control information, and the like of the system in the hospital to and from the plurality of image capturing apparatuses 101, electronic medical record management apparatuses 103, electronic medical record terminal apparatuses 104, and image management apparatuses 105, as necessary.

In the present embodiment, the image capturing apparatus 101, the electronic medical record terminal apparatus 104, the electronic medical record management apparatus 103, the image management apparatus 105, and the image capturing control apparatus 106 are described as being separate apparatuses, but the present disclosure is not limited thereto. The functions of two or more apparatuses may be realized by one apparatus, such as by dividing the electronic medical record terminal apparatus 104, the electronic medical record management apparatus 103, the image capturing control apparatus 106, and the image management apparatus 105 into application software units or virtualization region units of an operating system and constructing them in the same housing, for example. This makes it possible to configure an appropriately priced image capturing system in accordance with the load and capacity required by the system.

Further, in the medical system illustrated in FIG. 1, one of each apparatus is illustrated, but the present disclosure is not limited thereto, and a plurality of respective apparatuses may be connected.

### [Image Capturing Apparatus 101]

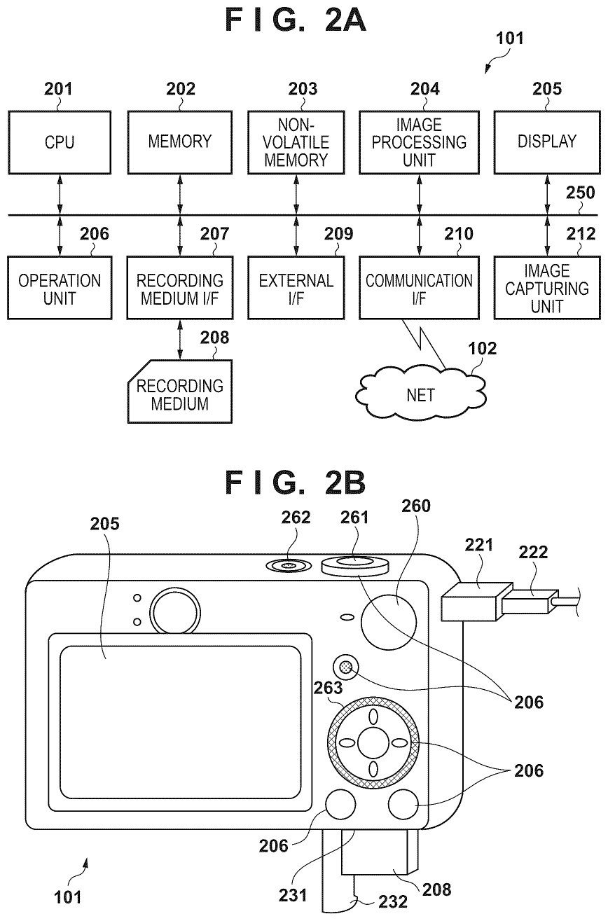

Next, a digital still camera will be described as an example of the image capturing apparatus 101 according to the present embodiment with reference to FIGS. 2A and 2B. FIG. 2A is a block diagram illustrating an example of a hardware configuration of the image capturing apparatus 101 according to the present embodiment. In FIG. 2A, a CPU 201, a memory 202, a non-volatile memory 203, an image processing unit 204, a display 205, an operation unit 206, a recording medium I/F 207, an external I/F 209, a communication I/F 210, and an image capturing unit 212 are connected to an internal bus 250. The respective units connected to the internal bus 250 are configured to be capable of exchanging data with each other via the internal bus 250.

The memory 202 is constituted by, for example, a RAM (such as a volatile memory in which a semiconductor device is used), and the CPU 201 controls each unit of the image capturing apparatus 101, for example, in accordance with a program stored in the non-volatile memory 203, by using the memory 202 as a working memory. The non-volatile memory 203 is constituted by, for example, a hard disk (HDD), a ROM, or the like, and stores image data, voice data, other data, various programs for the CPU 201 to operate (e.g., a program for medical image capturing), and the like. Processing according to the present embodiment can be performed by the CPU 201 reading out the program to the memory 202 and activating the program. The non-volatile memory 203 may hold not only the program for medical image capturing but also a program for general image capturing, in which case, the programs can be switched and used.

The image processing unit 204 performs various kinds of image processing on an image captured by the image capturing unit 212, an image stored in the non-volatile memory 203 or a recording medium 208, an image obtained via the external I/F 209, an image obtained via the communication I/F 210, and the like based on the control of the CPU 201. The image processing to be performed by the image processing unit 204 includes A/D conversion processing, D/A conversion processing, image data encoding processing, compression processing, decoding processing, enlargement/reduction processing (resizing), noise reduction processing, color conversion processing, and the like. The image processing unit 204 may be constituted by a dedicated circuit block for performing specific image processing. Further, depending on the type of image processing, the CPU 201 may perform image processing in accordance with a program without using the image processing unit 204.

The display 205 displays a Graphical User Interface (GUI) screen and the like constituted by images and GUIs based on the control of the CPU 201. The CPU 201 controls respective units of the image capturing apparatus 101 so as to generate a display control signal in accordance with a program and generate a video signal for display on the display 205 and output the video signal to the display 205. The display 205 displays an image based on the outputted video signal. The display 205 may be constituted by an external monitor, in which case elements included in the image capturing apparatus 101 do not go beyond an interface for outputting a video signal for display on the display 205.

The operation unit 206 includes operation members for accepting user operations, such as buttons, dials, and a touch panel.

The recording medium 208, such as a memory card, a CD, or a DVD, can be mounted on the recording medium I/F 207, and the recording medium I/F 207 reads out data from the mounted recording medium 208 and writes data to the recording medium 208 based on the control of the CPU 201.

The external I/F 209 is an interface for connecting to an external device by wired cable or wirelessly to perform input/output of image signals and audio signals, power supply, and charging.

The communication I/F 210 is an interface for communicating with an external device to transmit and receive various types of data, such as files and commands.

The image capturing unit 212 includes a group of lenses (image capturing lenses) that includes a zoom lens and a focus lens, a shutter that includes an aperture function, an image capturing element, an A/D converter that converts an analog signal outputted from the image capturing element into a digital signal, and a barrier that covers the image capturing system to prevent contamination and damage. The image capturing element is constituted by a CCD, a CMOS element, or the like that converts an optical image that has entered via the image capturing lenses and the shutter to an electric signal and is capable of capturing still images and moving images. The image capturing lenses may be configured to be interchangeable.

The image processing unit 204 performs resizing processing and color conversion processing, such as predetermined pixel interpolation and reduction, on data obtained by being captured by the image capturing unit 212. The CPU 201 performs exposure control, focus detection control, and auto white balance (AWB) processing based on a calculation result obtained by the image processing unit 204. Further, video data for display, which has been captured by the image capturing unit 212 and subjected to image processing by the image processing unit 204, is displayed by the display 205. By converting a digital signal captured by the image capturing unit 212, first subjected to A/D conversion by the A/D converter and stored in the memory 202, to analog by the D/A converter, sequentially transferring it to and displaying it on the display 205, it is possible to perform live view display (LV display). A live view can be displayed in a still image capturing standby state, a moving image capturing standby state, and at the time of recording a moving image, and captured subject images are displayed in almost real time.

The CPU 201 controls the image capturing unit 212 and the image processing unit 204 to start operation for auto focus (AF) processing, auto exposure (AE) processing, AWB processing, and the like in response to an image capturing preparation instruction that is based on a user operation performed using the operation unit 206. Further, the CPU 201 controls operation for a series of image capturing processes in response to an image capturing instruction from the operation unit 206. This series of image capturing processes includes processing for controlling the image capturing unit 212 to perform main exposure and read out a signal from the image capturing element, performing image processing on the readout image signal in the image processing unit 204 to generate an image file, and recording the image file in the recording medium 208.

FIG. 2B is a view of the appearance of a digital camera as an example of the image capturing apparatus 101.

The display 205 displays an image and various kinds of information.

A connector 221 is a connector between the digital camera and a connection cable 222 for connecting to an external device, such as a personal computer or a printer.

The recording medium 208 is a recording medium, such as a memory card or a hard disk. A recording medium slot 231 is a slot for storing the recording medium 208. The recording medium 208 stored in the recording medium slot 231 can communicate with a digital camera and makes recording and playback possible. A lid 232 is a lid of the recording medium slot 231. FIG. 2B illustrates a state in which the lid 232 is opened and a part of the recording medium 208 is removed from the slot 231 and exposed.

The operation unit 206 is constituted by operation members such as various buttons, dials, and a touch panel for receiving various operations from a user. Further, the operation unit 206 includes a shutter button 261 for performing an image capturing instruction, a mode switching switch 260 for switching between various modes, a rotatable controller wheel 263, and a power switch 262 which is a push button for switching between power-on and power-off. Further, the touch panel is configured to be superimposed on the display 205 in a flat manner, and coordinate information corresponding to a touched position is outputted.

The respective operation members of the operation unit 206 are each assigned a function as appropriate for each situation by, for example, a selection operation on various icons displayed on the display 205, and act as various kinds of function buttons. Function buttons include, for example, an end button, a return button, an image scrolling button, a jump button, a filter button, an attribute change button, and the like. For example, when a menu button is pressed, a menu screen on which various settings can be made is displayed on the display 205. The user can intuitively perform various settings by using a menu screen displayed on the display 205 and four-way (up/down/left/right) buttons, a SET button, and the like.

The controller wheel 263 is used, for example, when instructing a selection item, alongside a directional button. Upon a rotation operation on the controller wheel 263, an electric pulse signal is generated in accordance with the amount of operation, and the CPU 301 controls the respective units of the digital camera based on the pulse signal. The angle of the rotation operation on the controller wheel 263, the number of rotations, and the like can be determined according to the pulse signal. The controller wheel 263 may be any operation member so long as rotation operations can be detected. For example, a dial operation member in which the controller wheel 263 itself rotates in response to a rotation operation of the user and generates a pulse signal may be assumed. Further, an operation member constituted by a touch sensor and in which the controller wheel 263 itself does not rotate and which detects a rotation operation or the like of the user's finger on the controller wheel 263 (i.e., a touch wheel) may be assumed.

An image capturing instruction can be performed by the user pressing the shutter button 261. Various image capturing parameters can be set using respective operation members included in the operation unit 206, such as the mode switching switch 260, the controller wheel 263, and the touch panel on the display 205.

Each image capturing apparatus 101 has a unique identification information (ID), which is hereinafter referred to as “camera ID”. Any form of ID may be used as the camera ID so long as it does not overlap within the system in which it is operated, such as a serial number, a self-generated ID, a Media Access Control Address (MAC) address, and a Universally Unique Identifier (UUID), for example.

Further, even if not directly assigned to the image capturing apparatus 101, any unique ID may be used so long as it is operated in a pair with the image capturing apparatus 101 or the electronic medical record terminal apparatus 104, such as an SD card, a staff ID, and other physical RFIDs, for example.

### [Image Capturing Control Apparatus 106]

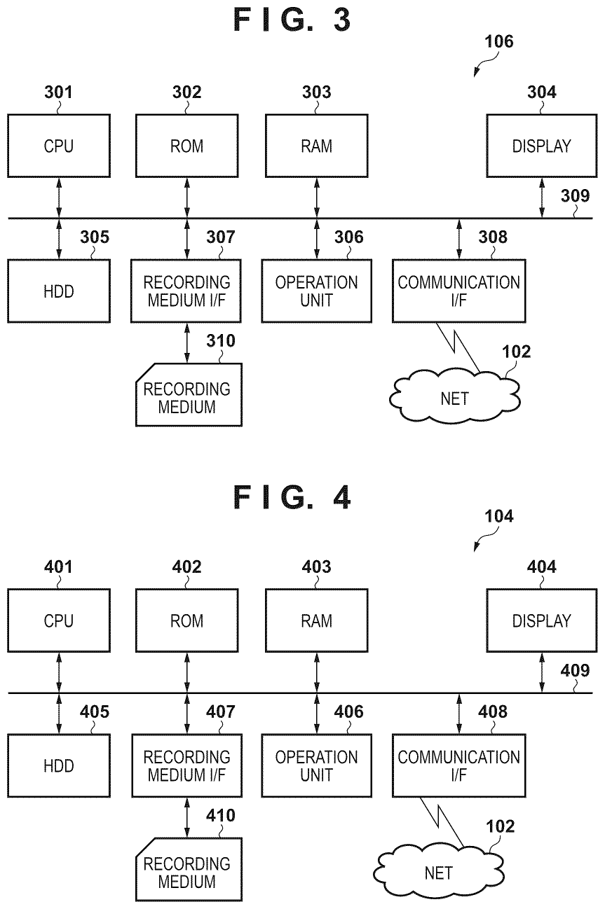

FIG. 3 is a block diagram illustrating a hardware configuration of a computer that operates as the image capturing control apparatus 106 according to the present embodiment. The image capturing control apparatus 106 functions by executing a predetermined control and processing program in the computer to perform processing that will be described below but the predetermined control and processing program may be provided and carried out within the local network 102 or on a server, such as one on a cloud.

A CPU 301 is responsible for control of the system. A ROM 302 stores operation processing procedures (e.g., programs for computer startup processing, basic input/output processing, etc.) of the CPU 301. A RAM 303 functions as a main memory of the CPU 301 and provides a work area for when the CPU 301 executes various processes. Various programs including a control program for realizing the processing that will be described later are loaded from a storage medium constituted by a Hard Disk Drive (HDD) 305, a Solid State Drive (SSD), or the like to the RAM 303 and executed by the CPU 301.

A display 304 performs various kinds of display under the control of the CPU 301. The display 304 may be configured by an external monitor, in which case elements included in the image capturing control apparatus 106 do not go beyond an interface for outputting a video signal for display on the display 304.

The Hard Disk Drive (HDD) 305 is used for storing and reading application programs, data, libraries, and the like.

An operation unit 306 includes operation members for accepting user operations, such as a character information input device (e.g., a keyboard), a pointing device (e.g., a mouse or a touch panel), buttons, dials, a joystick, a touch sensor, and a touch pad.

A recording medium 310, such as a memory card, a CD, or a DVD, can be mounted on a recording medium I/F 307, and the recording medium I/F 307 reads out data from the mounted recording medium 310 and writes data to the recording medium 310 based on the control of the CPU 301. This makes it possible to read out data captured and stored by the digital still camera.

A communication I/F 308 is connected to the network 102 via a wireless or wired communication line, and the image capturing control apparatus 106 transmits and receives data to and from an external device via the communication I/F 308. Further, depending on the type of communication I/F 308, it is possible to supply power to and charge a connection destination. In the present embodiment, when connected to the image capturing apparatus 101 via the communication I/F 308 by cable, it is possible to not only obtain a captured image from the image capturing apparatus 101 but also for the CPU 301 to perform processing for transmitting and receiving various kinds of data to from the image capturing apparatus 101 and for supplying power to and charging the image capturing apparatus 101.

A system bus 309 is constituted by an address bus, a data bus, and a control bus that connect the above respective units.

### [Electronic Medical Record Terminal Apparatus 104]

FIG. 4 is a block diagram illustrating a hardware configuration of a computer that operates as the electronic medical record terminal apparatus 104 according to the present embodiment, and the basic configuration is similar to that of the image capturing control apparatus 106 of FIG. 3. Regarding the electronic medical record terminal apparatus 104, in a system in a hospital, generally it is common for a plurality of electronic medical record terminal apparatuses 104 to be configured as client apparatuses for one electronic medical record management apparatus 103 and to be used by staff involved in medical practice. Since the respective elements 401 to 410 are the same as the respective elements 301 to 310 illustrated in FIG. 3, description thereof will be omitted.

Each electronic medical record terminal apparatus 104 according to the present embodiment can activate and use one electronic medical record application.

The electronic medical record terminal apparatus 104 connects to the electronic medical record management apparatus 103 via the network 102 or directly via a dedicated line and browses electronic medical records held by the electronic medical record management apparatus 103 by using the electronic medical record application or updates electronic medical records as necessary and sends the updated information to the electronic medical record management apparatus 103. With this, the electronic medical record management apparatus 103 can hold the latest information on electronic medical records.

Further, the electronic medical record terminal apparatus 104 and the electronic medical record application activated by a respective terminal apparatus each have a unique identification information (ID), referred to as “terminal ID” and “application ID”, respectively. As the terminal ID and the application ID, for example, a serial number or a self-generated ID can be used, and as the terminal ID, a MAC address, a UUID, or the like can be used. Further, even if not directly assigned to the electronic medical record terminal apparatus 104 or the electronic medical record application, any unique ID may be used so long as it is operated in a pair with an image capturing apparatus or an electronic medical record, such as an SD card, a staff ID, and other physical RFIDs, for example.

Since the electronic medical record terminal apparatus 104 and the electronic medical record application that is activated by the electronic medical record terminal apparatus 104 can be uniquely associated with each other, the terminal ID and the application ID can be used synonymously. Accordingly, in the following description, these are collectively referred to as “terminal/application ID” and refer to a terminal ID and/or an application ID.

### [Virtualization of System Apparatuses]

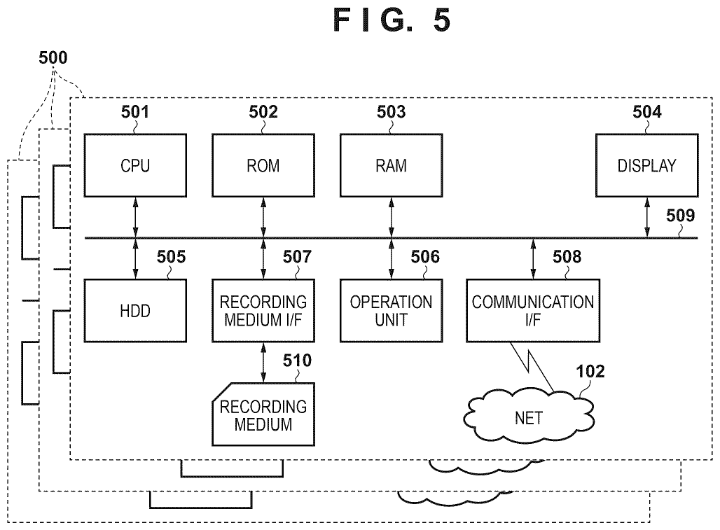

The electronic medical record management apparatus 103, the electronic medical record terminal apparatus 104, the image management apparatus 105, and the image capturing control apparatus 106 may be realized as physical computers and predetermined control/processing programs in respective units as in FIGS. 3 and 4, but these physical computer resources (e.g., a CPU, a GPU, a RAM, a ROM, a network, a hub, etc.) may be used to realize, by virtual division, for each user authority or department, respective processing blocks (a CPU 501, a ROM 502, a RAM 503, a display 504, an HDD 505, an operation unit 506, a recording medium I/F 507, a communication I/F 508 connected to the computer network 102, a system bus 509 connecting the respective units, and a recording medium 510) as a virtual container as indicated by reference numerals 500 of FIG. 5, thereby providing functions.

Although computer virtualization such as that for the image capturing control apparatus 106 is illustrated here, various kinds of other apparatuses constituting the system may similarly be virtualized to a scope that does not exceed physical device limitations.

This makes it possible to efficiently utilize the system in the hospital by allocating finite processing resources of physical computers according to, for example, the usage load of the medical department or according to a change in how busy it is depending on the time of day. This makes it possible to reduce the introduction cost and operation cost of the entire system and easily update the system and software, thereby improving the work efficiency of the user.

In the following description, it is assumed that there are a plurality of image capturing apparatuses 101 and electronic medical record terminal apparatuses 104 to be operated in the hospital, each capable of being connected to the network 102 and being used by a plurality of users (staff). Therefore, description will be given assuming that the power of each apparatus is irregularly turned on/off. Although the image capturing control apparatus 106 will be described as that in which respective processing blocks are constructed as a virtual container as in FIG. 5 by using physical computer resources (e.g., a CPU, a GPU, a RAM, a ROM, a network, a hub, etc.), thereby providing functions, the image capturing control apparatus 106 may be configured using physical resources as in FIG. 3.

### [Pairing Processing in Image Capturing Apparatus]

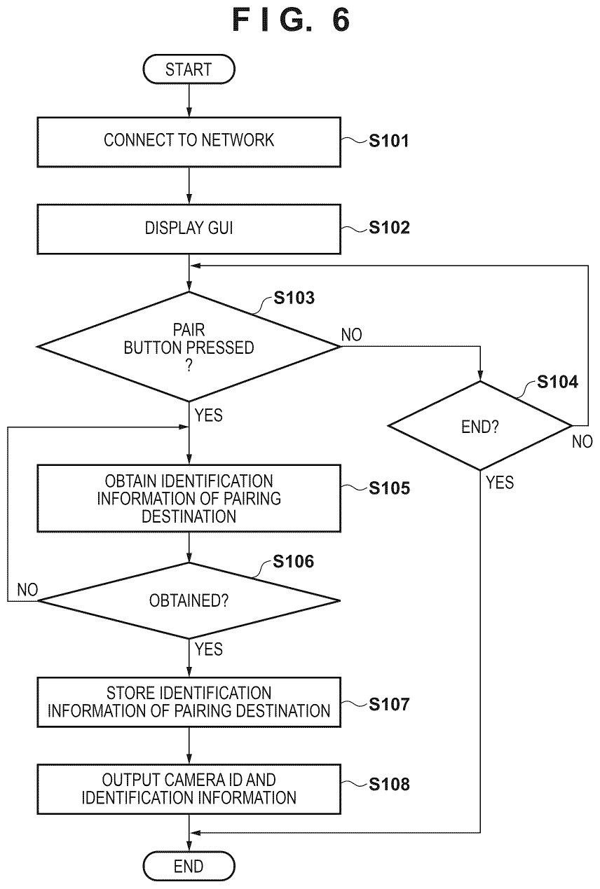

Next, pairing processing in the image capturing apparatus 101 to be performed in the present embodiment will be described with reference to FIGS. 6 to 9B. In the pairing processing, processing for associating (pairing) the image capturing apparatus 101 and the electronic medical record terminal apparatus 104 and/or the electronic medical record application activated by the electronic medical record terminal apparatus 104 is performed. FIG. 6 is a flowchart for explaining processing in the image capturing apparatus 101.

When power is turned on by using the power switch 262 or a release of the sleep state is instructed, in step S101 the CPU 201 connects to the network 102 via the communication I/F 210 to communicate with the image capturing control apparatus 106.

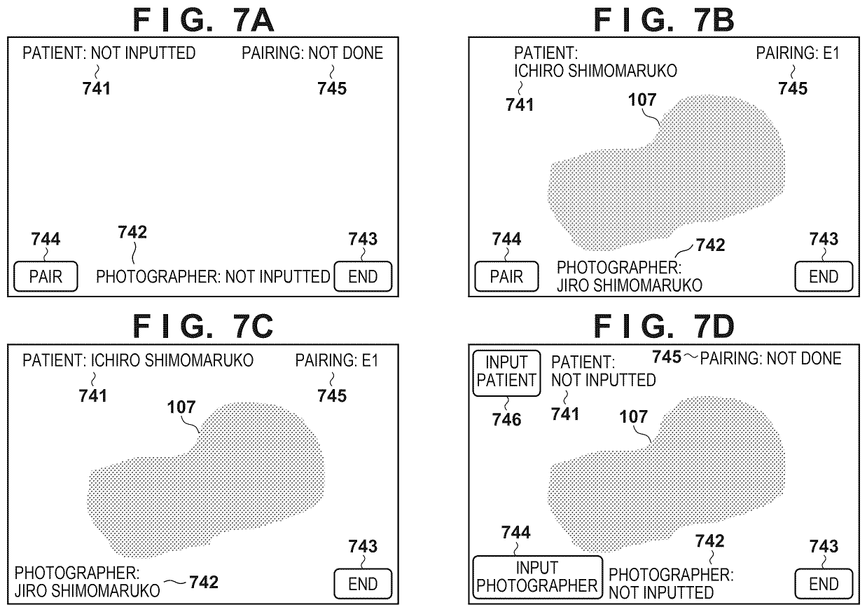

In step S102, the CPU 201 displays a GUI screen as illustrated in FIG. 7A on the display 205. In FIG. 7A, reference numeral 741 indicates a patient name, reference numeral 742 indicates a photographer name, reference numeral 743 indicates an end button, reference numeral 744 indicates a pair button (instruction display), and reference numeral 745 indicates a pairing state. In the image capturing apparatus 101 immediately after activation, the patient name 741 and the photographer name 742 have not been obtained, and thus, “not inputted” is displayed. Further, pairing has not been performed, and thus, “not done” is displayed. By thus configuring the GUI screen, a subject, related metadata, and a pairing state can be displayed, inputted, confirmed, or updated as necessary.

In step S103, the CPU 201 determines whether the pair button 744 has been pressed. If the pair button 744 has not been pressed, the processing proceeds to step S104 and it is determined whether the end button 743 has been pressed, and if the end button 743 has been pressed, the processing ends. If the end button 743 has not been pressed, the processing returns to step S102. If the pair button 744 has been pressed, the processing proceeds to step S105, and the pairing processing is started.

In step S105, identification information such as the terminal ID of the electronic medical record terminal apparatus 104 or the application ID of the electronic medical record application to be paired with is obtained.

Here, an example of a method of obtaining a terminal ID or an application ID will be described. Here, a case where the terminal ID or the application ID has been converted into a one-dimensional, two-dimensional, or color code, an RFID, and the like and is captured by the image capturing apparatus 101 and analyzed will be described.

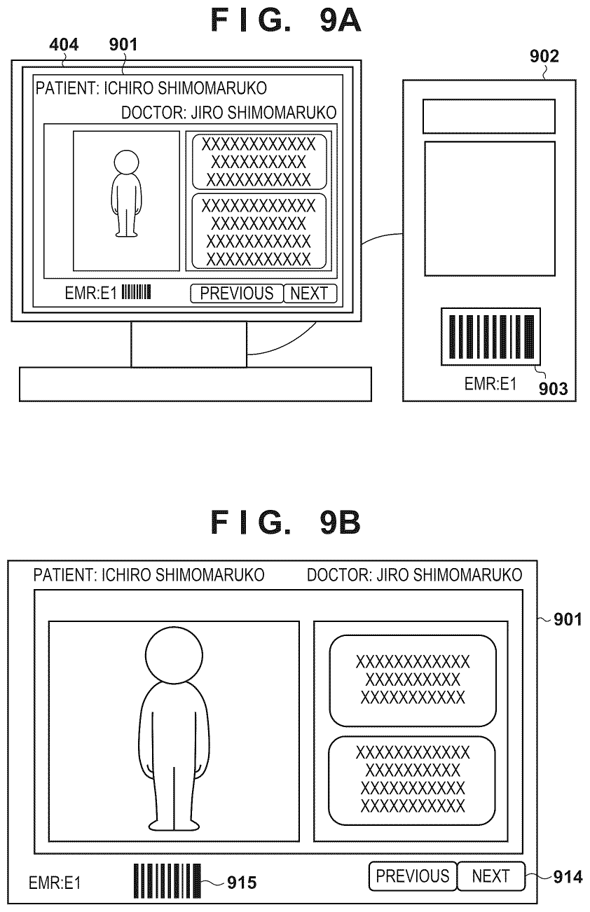

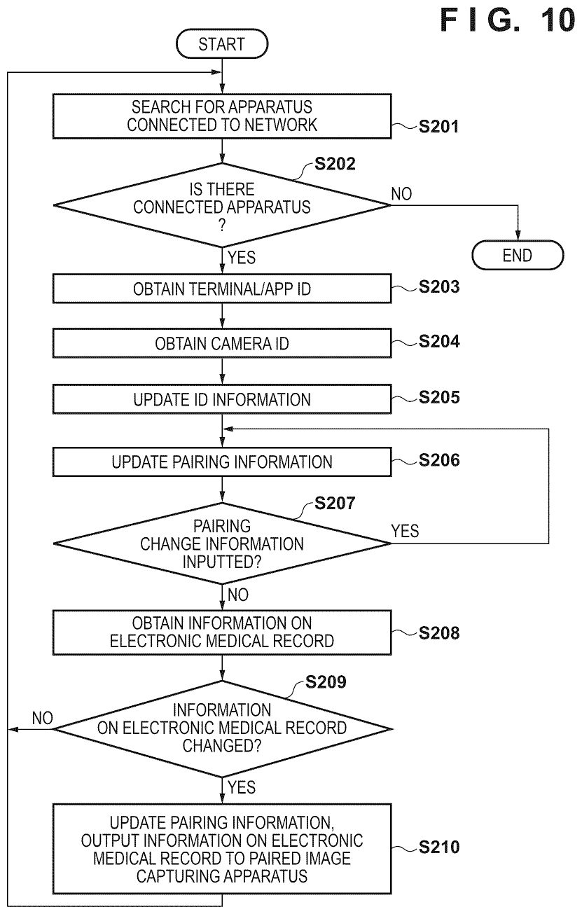

FIG. 9A illustrates a case where a window 901 of the electronic medical record application is displayed on a display 404 of the electronic medical record terminal apparatus 104. In FIG. 9A, an ID code 903 is a terminal ID converted into a one-dimensional barcode and printed and is physically attached to a computer 902 of the electronic medical record terminal apparatus 104. Further, FIG. 9B illustrates an electronic medical record displayed in the window 901 of the electronic medical record application. In FIG. 9B, an ID code 915 represents a one-dimensional barcode into which an application ID generated by the electronic medical record application has been converted or a terminal ID of the electronic medical record terminal apparatus 104 read out by the electronic medical record application.

The image capturing apparatus 101 captures the ID code 903 or the ID code 915 thus provided and, by analyzing the image of the captured ID code by using a known method, obtains a terminal/application ID, which is identification information.

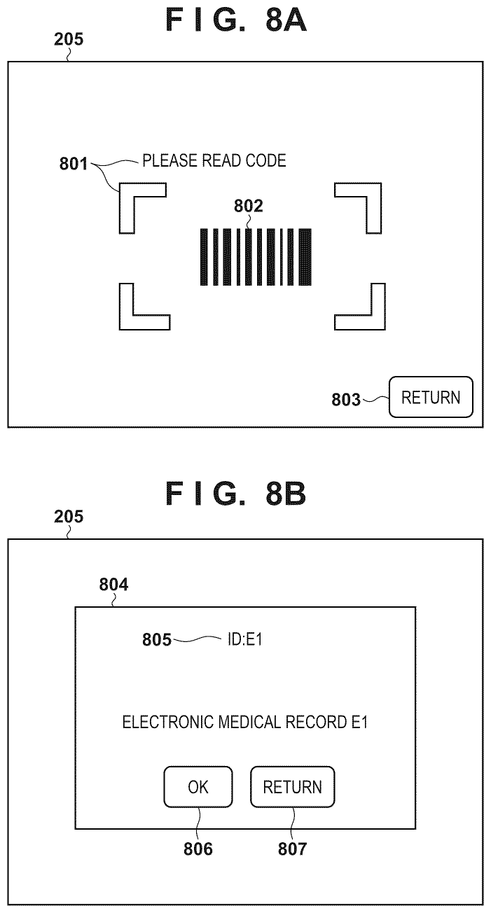

FIG. 8A illustrates an example of a guidance screen to be displayed on the display 205 of the image capturing apparatus 101 for reading the ID code 903 or the ID code 915 when the pair button 744 is pressed. Reference numeral 801 may be a guide display for when reading identification information, such as a one-dimensional code, a two-dimensional code, character, and a recognition pattern as indicated by reference numeral 802, for example, and may be displayed to create a suitable composition. Further, a configuration in which the type of reading target is set in advance or determination processing or the like is performed in advance and the guidance or guide is changed in accordance with the determination result may be taken. This makes it easy to adjust composition in accordance with a target pattern, thereby improving reading accuracy, speed, robustness, and the like. A return button 803 is a button for returning to the previous screen.

By thus configuring the terminal/application ID, it is possible to perform suitable operation for the functions of the in-hospital system and the electronic medical record application, the staff operation status of electronic medical record terminals, and the like.

Here, description will be given assuming that an image of an ID code is captured and analyzed, but so long as it is attached to the electronic medical record terminal apparatus 104, which is to be paired with the image capturing apparatus 101, the terminal/application ID may be obtained using short-range wireless communication, such as an IC tag, an RFID, or Bluetooth. Further, depending on the operation of the image capturing apparatus 101 in the hospital, the initial state at the time of power activation may be a pairable state (guidance screen illustrated in FIG. 8A). Further, a configuration in which the current pairing information is stored in the image capturing apparatus 101 or the image capturing control apparatus 106 at the time of power-off such that operation can be started in the stored pairing state at the next activation, thereby reducing the effort for operation may be taken.

When the guidance screen is transitioned to, image capturing may be performed using image capturing settings for ID code image capturing (e.g., an exposure value, a focal length, etc.) stored in the image capturing apparatus 101. This makes it possible to, even in an environment in which or with a subject for which suitable image capturing parameters are greatly different when capturing an image of the patient and when capturing an image of an ID code, reduce the effort in adjusting image capturing parameters.

In step S106, the CPU 201 of the image capturing apparatus 101 determines whether a terminal/application ID (identification information) has been obtained. If a terminal/application ID has been obtained, the processing proceeds to step S107, and if a terminal/application ID could not be obtained such as if reading has failed (e.g., if the ID code analysis result returns an error), the processing returns to step S105.

Further, the analysis result may be displayed on the display 205 to obtain user confirmation. FIG. 8B is a diagram illustrating a display example 804 for confirming the analysis result. Reference numeral 805 indicates a read terminal/application ID. If the displayed terminal/application ID is correct, an OK button 806 is pressed. Further, if the confirmed terminal/application ID is incorrect, or if it is confirmed that it is not the pairing target due to an operation error or the like, a return button 807 is pressed, the obtained pairing information is discarded, and the processing returns to step S105. Alternatively, step S102 may be returned to and the pairing processing may be performed again from the beginning.

In step S107, the CPU 201 stores, in the memory 202, the non-volatile memory 203, the recording medium 208, or the like, the terminal/application ID obtained by analyzing the read ID code 903 and/or ID code 915.

Then, in step S108, the camera ID of the image capturing apparatus 101 and the obtained terminal ID or application ID are transmitted to the image capturing control apparatus 106 via the network 102, and the pairing processing in the image capturing apparatus 101 ends.

As described above, a manual image capturing mechanism in which, when reading an ID code at the time of pairing, an image is captured and the captured image is analyzed is conceivable. In such a mechanism in which manual image capturing is used, although the amount of analysis is often small, the image capturing shutter must be pressed once each time the composition is adjusted, resulting in a large number of operations of the user and a large operational load. Therefore, a mechanism in which live view images are transmitted at predetermined intervals and image analysis is performed until successful recognition may be used. In this case, since image capturing to image analysis and success as described above is automatically performed, generally the load of analysis amount and communication amount momentarily increases, but the number of operations of the user can be significantly reduced.

The GUI as illustrated in FIG. 7A may be displayed, for example, in a case where the state of connection between the image capturing apparatus 101 and the network 102 is poor, or the like. With such a display, it is possible to perform appropriate information output in accordance with the status of coordination between the image capturing apparatus 101 and the system, and thus, it is possible for the photographer to perform an appropriate operation in accordance with the situation, such as confirming the devices connected to the network and switching the access point with which a connection is to be established, for example.

### [Pairing Management Processing in Image Capturing Control Apparatus]

Next, pairing management processing in the image capturing control apparatus 106 will be described with reference to a flowchart of FIG. 10.

In step S201, the CPU 301 of the image capturing control apparatus 106 searches for image capturing apparatuses 101 and electronic medical record terminal apparatuses 104, which are connected to the network 102, via the network 102 and determines the state of connection of each connected apparatus. The image capturing control apparatus 106, the image capturing apparatuses 101, and the electronic medical record management apparatus 103 perform synchronous communication or asynchronous communication according to the communication protocol, but regarding the detection method and the connection/disconnection method, a connection may be established with asynchronous communication, or a method in which periodic monitoring (e.g., polling) is performed using synchronous communication may be taken.

Regarding determination of the connection state, communication with each image capturing apparatus 101 and electronic medical record terminal apparatus 104 is performed using the network 102 and responses are confirmed, and if that response is a normal response, it is determined to be “connected”, and if that response is an abnormal response or there is no response, it is determined to be “not connected”.

In step S202, the CPU 301 determines whether there is a “connected” apparatus and, if there is a “connected” apparatus, proceeds to step S203. If there is no “connected” apparatus, it is determined that there is a problem with the connection via the network 102, and the processing is ended. At this time, if the responses are “not connected” at a group level, such as the medical department or floor where each image capturing apparatus 101 and each electronic medical record terminal apparatus 104 respond, the responses may be confirmed with a communication relay device or the like constituting the network 102 and an alert may be outputted.

In step S203, the CPU 301 queries each electronic medical record terminal apparatus 104 in a connected state and obtains a terminal/application ID.

Next, in step S204, the CPU 301 obtains the camera ID of each image capturing apparatus 101 in a state of connection via the network 102.

In step S205, the CPU 301 updates ID information, which are the terminal/application ID and the camera ID and stored in the storage region of the ROM 302 or the RAM 303, with the terminal/application ID and the camera ID obtained in steps S203 and S204. For example, an ID that is not stored among the terminal/application ID and the camera ID obtained in steps S203 and S204 are newly registered. Further, an ID that could not be obtained in step S203 or S204 among the terminal/application ID and the camera ID stored in the storage region of the ROM 302 or the RAM 303 is deleted, or “not connected” information is added. This makes it possible to prevent the terminal/application ID and the camera ID from being registered in duplicate and also prevent the image capturing apparatus 101 and the electronic medical record terminal apparatus 104 that are not in a connected state from being paired, for example, due to a power-off.

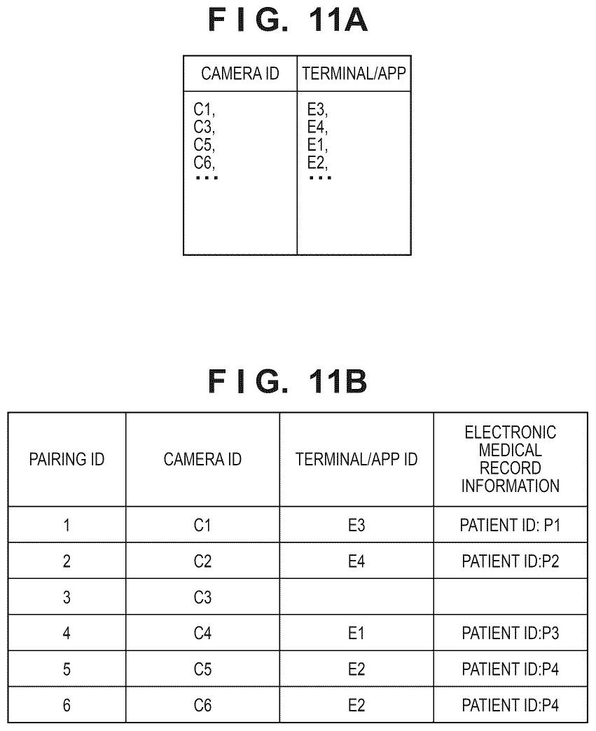

FIG. 11A illustrates a list of camera IDs of all the image capturing apparatuses 101 in an activated state and terminal/application IDs of the electronic medical record terminal apparatus 104 and the electronic medical record applications that are managed by the image capturing control apparatus 106. FIG. 11A indicates that the image capturing apparatuses 101 with camera IDs, “C1”, “C3”, “C5”, and “C6”, have been detected, and the electronic medical record terminal apparatuses 104 or electronic medical record applications with terminal/application IDs, “E1”, “E2”, “E3”, and “E4” have been detected.

In step S206, the CPU 301 of the image capturing control apparatus 106 updates pairing information based on the ID information illustrated in FIG. 11A. FIG. 11B is a diagram illustrating an example of pairing information managed by the image capturing control apparatus 106 and illustrates a list of combinations (associations) of a pairing ID, a camera ID, a terminal/application ID, and electronic medical record information. For example, it can be seen that, in pairing ID “2”, camera ID “C2” and terminal/application ID “E4” are paired. Further, it can be seen that, in pairing ID “3”, the image capturing apparatus 101 with camera ID “C3” is connected to the network 102 but is not paired with any electronic medical record terminal apparatus 104 or electronic medical record application. Further, it can be seen that, in pairing IDs “5” and “6”, two image capturing apparatuses 101 with camera IDs “C5” and “C6” are paired with the same terminal/application ID “E2”. Further, the electronic medical record information holds information on an electronic medical record corresponding to the terminal/application ID and is obtained from the electronic medical record management apparatus 103 in step S208, which will be described later.

Next, in step S207, the CPU 301 of the image capturing control apparatus 106 determines whether pairing change information, such as addition of new pairing information and disconnection of pairing, has been inputted from the image capturing apparatus 101. Here, for example, when a camera ID and a terminal/application ID are transmitted from a respective image capturing apparatus 101 in step S108 of FIG. 6, it is determined that change information has been inputted. Upon input of pairing change information, the processing returns to step S206, and the pairing information is updated based on the change information. If no change information has been inputted, the processing proceeds to step S208.

In step S208, the CPU 301 obtains information on an electronic medical record currently being viewed in a corresponding electronic medical record application from the electronic medical record management apparatus 103 by using the terminal/application ID registered in the pairing information. The information on an electronic medical record obtained here need only be information that can be uniquely associated with an electronic medical record being viewed and includes at least identification information (patient ID) on the patient, such as the patient name and the patient number arbitrarily allocated to the patient. Staff information, patient information, medical treatment information, history, and the like may be additionally included. Then, in step S209, the CPU 301 compares the information on the electronic medical record obtained in step S208 with the information on the electronic medical record held in the pairing information and determines whether there has been a change. Regarding newly registered pairing information, since the information on the electronic medical record is not registered, it is determined that there has been a change in the information on the electronic medical record obtained in step S208.

If the information on the electronic medical record has been changed, the pairing information is updated in step S210, and the information on the electronic medical record after the change is outputted to the image capturing apparatus 101 with the corresponding camera ID.

When the processing of step S210 is completed, the processing returns to step S201 and the above processing is repeated.

By transmitting pairing information from the image capturing apparatus to the image capturing control apparatus and creating a list of pairing information of the entire system and storing the list in this manner, it is possible to control and recognize the pairing of duplicate equipment. This makes it possible to allow efficient pairing of devices and reduce erroneous operations, as well as retain pairing information even when the power of the image capturing apparatus or electronic medical record terminal apparatus is individually operated. Further, it is possible to, when the power of an apparatus is turned on again, continue to use the stored pairing information.

In the above processing, it is assumed that in a case where a connected apparatus could not be detected step S202, the CPU 301 of the image capturing control apparatus 106 determines that the communication status is abnormal and thus control is difficult and ends the processing. However, instead of determining the connected state only at the timing of step S202, the same processing may be performed at each processing step or at fixed intervals. If the communication response is poor at that time, the processing may similarly be ended or retry processing for confirming the communication response a number of times may be performed. Further, by clearing previously used metadata, incorrect metadata may be prevented from being associated with other captured data.

By thus proceeding with the processing while confirming the communication status as necessary, it is possible to prevent the control processing from stopping (deadlock), and by prioritizing processing for clearing metadata at the time of an abnormality, it is possible to prevent a mistake in the metadata associated with the captured data.

Further, in the above example, the image capturing apparatus 101 and the electronic medical record terminal apparatus 104 are detected by the image capturing control apparatus 106, but for example, only the image capturing apparatus 101 may be detected by the image capturing control apparatus 106 and information related to the electronic medical record terminal apparatus 104 may be detected by the electronic medical record management apparatus 103 or in a database or the like that reference the data. By doing so, it becomes possible to perform operations suitable for the system constituting a respective hospital.

Further, in the above processing, the CPU 301 may determine the usage state of the electronic medical record application and use it for power saving of the image capturing apparatus 101. The usage states of the electronic medical record application are, for example, an initialization processing state (e.g., during activation or termination), a staff access authentication state, an examination state in which an electronic medical record is open and referenced, a state in which patient, staff, image, and other data is transmitted and received, an electronic medical record editing state, an electronic medical record storage operation state, an electronic medical record terminal login/logoff state of staff, and the like.

The CPU 301 of the image capturing control apparatus 106 determines whether to prioritize power saving processing for the image capturing apparatus 101 that is a pairing partner of an electronic medical record application in accordance with the usage state of an electronic medical record. For example, if the usage state of the terminal/application ID E4 is an initialization processing state (e.g., during activation or termination), in a case of an unreferenced state (e.g., electronic medical records are closed), or in a case where the staff's electronic medical record terminal is in an unauthenticated state (e.g., logged off), and the like, it is highly likely that the examination is not being performed. In such a case, the image capturing apparatus C2 determines to prioritize power saving processing.

Then, the CPU 301 of the image capturing control apparatus 106 notifies the image capturing apparatus 101 to prioritize power saving processing. The power saving processing is determined by the unique specifications of the image capturing apparatus 101. For example, the usage states of various members, such as the display state of the liquid crystal panel of the image capturing apparatus 101, the standby states of the image capturing engine and the image processing engine, and a communication standby state, are controlled.

Meanwhile, if the usage state of the terminal/application ID E2 is an examination state in which an electronic medical record is open and referenced, a transmission/reception state in which image data and the like are being transmitted and received, an editing state in which an electronic medical record is being edited, a storage operation state in which an electronic medical record storage processing is being performed, an authenticated state in which staff is logged in to the electronic medical record terminal, and the like, it is highly likely that the examination is being performed. In such a case, it is determined to not prioritize power saving processing of the image capturing apparatuses C5 and C6 (prioritize communication processing).

Then, the CPU 301 of the image capturing control apparatus 106 notifies the image capturing apparatus 101 to prioritize processing efficiency regardless of power consumption for communication and the like. The processing of prioritizing communication here includes a notification to prioritize the responsiveness of members related to image capturing processing time of the image capturing apparatus 101 itself, input of patient information and staff information to the image capturing apparatus 101, uploading of images, and the like.

By thus implementing power saving of the image capturing apparatus 101 by switching it in accordance with the usage state of the electronic medical record terminal apparatus 104, it is possible to quickly capture an image in an operating state and operate the image capturing apparatus 101 for a long time without interruption of work while saving its stored power, and thus, work efficiency is improved.

### [Image Capturing Processing in Image Capturing Apparatus]

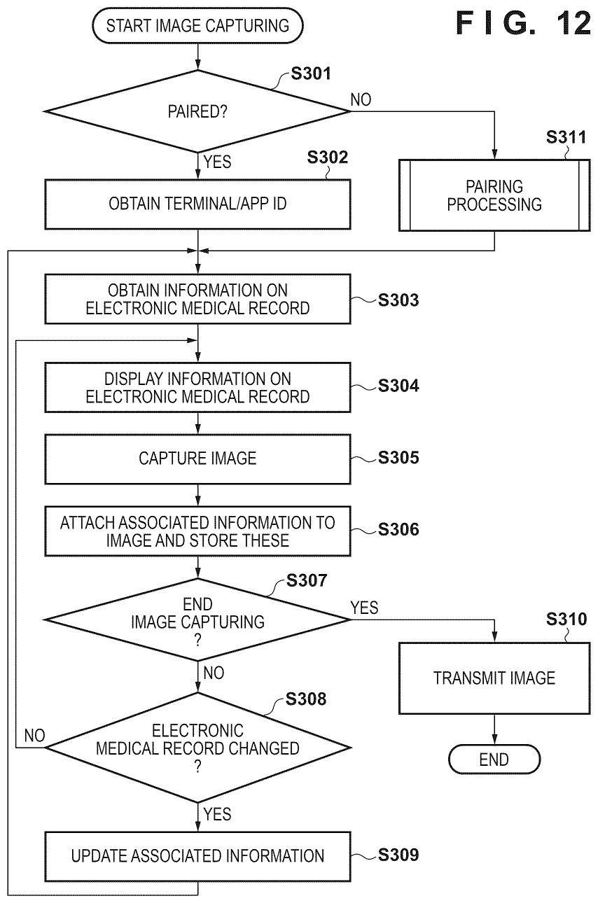

Next, the image capturing processing according to the present embodiment in the image capturing apparatus 101 will be described. FIG. 12 is a flowchart for explaining image capturing processing according to the present embodiment in the image capturing apparatus 101. It is assumed that a photographer who performs image capturing processing in this processing is, for example, in addition to a doctor or nurse, other staff in the hospital, such as a technician or assistant, and it is assumed that information including a respective photographer ID is stored in the electronic medical record management apparatus 103.

Upon a press of the power switch 262 or a release of the sleep state, the CPU 201 of the image capturing apparatus 101 enables a user interface and at the same time transitions to a state in which an image of an affected part can be captured. A configuration may be taken in which, depending on the operation of the image capturing apparatus 101 in the hospital, the initial state at the time of activation is set to a state in which an image of an affected part can be captured, thereby allowing reduction in operation effort.

Further, if the image capturing apparatus 101 is not connected to the network 102 at this time, it may be connected to the network 102 to enable it to communicate with the image capturing control apparatus 106. Data and parameters set in the hospital and the medical system may be downloaded and used for subsequent operations.

Upon the start of the image capturing processing, in step S301 the CPU 201 of the image capturing apparatus 101 determines whether it has been paired. This determination may be performed based on whether pairing information is held in the memory 202, the non-volatile memory 203, or the like or may be performed by querying the image capturing control apparatus 106 as to whether it has been paired. If not paired, the processing proceeds to step S311, and the pairing processing described with reference to FIG. 6 is performed.

Meanwhile, in step S301 if it is determined by the CPU 201 that it is paired, in step S302 the paired terminal/application ID is obtained, and the processing proceeds to step S303. Here, for example, the terminal/application ID may be read out from the pairing information held in the memory 202, the non-volatile memory 203, or the like, or the image capturing control apparatus 106 may be queried.

In step S303, the CPU 201 obtains information on an electronic medical record associated with the terminal/application ID from the image capturing control apparatus 106 and stores the obtained information on the electronic medical record in the memory 202 as associated information. At this time, photographer information (e.g., ID, name, medical department, age, sex, history of past treatments) may be obtained together.

Then, in step S304, the obtained information on the electronic medical record and, if obtained, the photographer information are displayed on the display 205. An example of a GUI displayed at this time is illustrated in FIG. 7B. In the example illustrated in FIG. 7B, “E1” is displayed as the pairing state 745 on an LV image and indicates being paired with the electronic medical record terminal apparatus 104 or application with the terminal/application ID E1. Further, “Ichiro Shimomaruko” is displayed as the patient name 741, and “Jiro Shimomaruko” as the photographer name 742. The photographer views this screen and, if there is an error in the obtained content, can redo the pairing by pressing the pair button 744.

In step S305, in response to a press of a shutter button included in the operation unit 206 by the photographer, the image capturing unit 212 captures an image of an affected part of the patient. During image capturing, a GUI as illustrated in FIG. 7C may be changed to. FIG. 7C is a state in which the pair button 744 is not displayed in an image capturing screen. By not displaying the pair button 744, it is possible to prevent releasing pairing at an unintended timing, such as erroneously starting pairing processing due to erroneous operation or the like while capturing an image of an affected part.

Then, in step S306, associated information held in the memory 202 is attached to image data of the captured image as metadata, and these are temporarily stored in the memory 202, the non-volatile memory 203, the recording medium 208, or the like. Further, the captured image is displayed on the display 205 for a predetermined time. At this time, the GUI as illustrated in FIG. 7B is displayed again, but instead of an LV image, the captured image is displayed. Information such as image capturing date and image capturing parameters used for image capturing may additionally be attached to the metadata. Further, these pieces of metadata may be written in the metadata region or the like of the captured data, or a separate metadata file may be associated with and attached to the captured data as another logical file.

In step S307, it is determined whether an end of image capturing has been instructed by a press of the end button 743. In case of continuing image capturing, in step S308 the image capturing apparatus 101 determines whether information indicating that a change has been made to an electronic medical record being viewed in the paired electronic medical record application has been received from the image capturing control apparatus 106. If there is no change, the processing returns to step S304 to continue image capturing, and if any change has been made, the processing returns to step S304 after updating associated information with the information on the electronic medical record transmitted in step S309. With this, for example, when the patient to be examined is changed by using “previous” and “next” buttons 914 of FIG. 9B and the paired electronic medical record being viewed on the electronic medical record terminal apparatus 104 is changed, the associated information is updated by using the pairing information.

Thus, even if the photographer does not perform the operation of updating the associated information, the information on the electronic medical record being browsed can be correctly associated with the obtained image by performing the pairing once.

Meanwhile, in step S307 if an end of image capturing is instructed, in step S310 the captured image and associated information recorded in the metadata are transmitted and the image capturing processing is ended. For example, the image capturing apparatus 101 performs transmission to the image management apparatus 105 via the image capturing control apparatus 106 or directly. The image management apparatus 105 may include a storage apparatus, such as a predetermined HDD or server, for example, or may be connected to a storage region of a cloud system. Further, at this time, storage locations may be organized and sorted according to the contents of the metadata or may be given search tags.

Further, assuming that a full set of necessary image capturing of an affected part has been completed (end of the image capturing state), the image capturing screen is returned to, but at this time, the patient name 741 and the photographer name 742 may be cleared and the GUI illustrated in FIG. 7A may be returned to.

By thus applying the privacy policy of the hospital facility, the department, and the photographer and clearing personal information, personal information will not continue to be retained, and thus, it is possible to safely operate devices in terms of information management.

As described above, according to the first embodiment, patient information of the electronic medical record being browsed and photographer information, which are indispensable for image data organization and analysis, are recorded for each piece of image data, without an operation in which the photographer manually inputs or updates associated information each time they capture an image. This makes it possible to reduce the effort required for operation in capturing an image of the affected part of the patient, concentrate on examination and image capturing, and reduce image mix-up, such as erroneous association of an image and associated information, and the effort in organization and confirmation.

Further, it is possible to carry out later image organization, follow-up observation, image analysis, and the like efficiently and with less errors. For example, by automatically organizing images of affected parts, it is possible to reduce the effort and work in organization, analyze the image for each symptom, and easily observe changes over time. Further, it is possible to use various search conditions at a later date based on doctor information and patient information to reconfirm images or use images for conferences. Thus, it is possible to improve the operational efficiency related to the medical treatment of photographers and staff, and to support the diagnosis.

The timing and frequency at which the image capturing apparatus 101 confirms whether a change has been made to an electronic medical record is not limited to the above example and this confirmation may be performed at predetermined intervals while an image is not being captured.

Further, in the above example, it is assumed that the image capturing control apparatus 106 detects that a change has been made to the electronic medical record and transmits information on the electronic medical record after the change to the corresponding image capturing apparatus 101, but the present disclosure is not limited thereto. For example, the image capturing apparatus 101 may transmit the camera ID and the terminal/application ID to the image capturing control apparatus 106 and query whether a change has been made to the electronic medical record being viewed in the paired electronic medical record application.

Further, in the above example, image capturing being performed when pairing is successful has been described, but if there is no information on an electronic medical record corresponding to the paired terminal/application ID due to no pairing, insufficient information, a change in the information on or state of the electronic medical record, and the like, temporary metadata (e.g., a unique ID of the image capturing apparatus, image capturing time, received time, number of captured images, recognition information obtained by image analysis, etc.) may be inputted. Further, at the output destination of the image, recording may be made in the metadata region of the image or a generated file may be associated. This makes it possible to, even when the electronic medical record information of the terminal/application ID is not associated, record official patient information, staff information, and the like later as metadata of the image or use these as reference information for when manually organizing images.

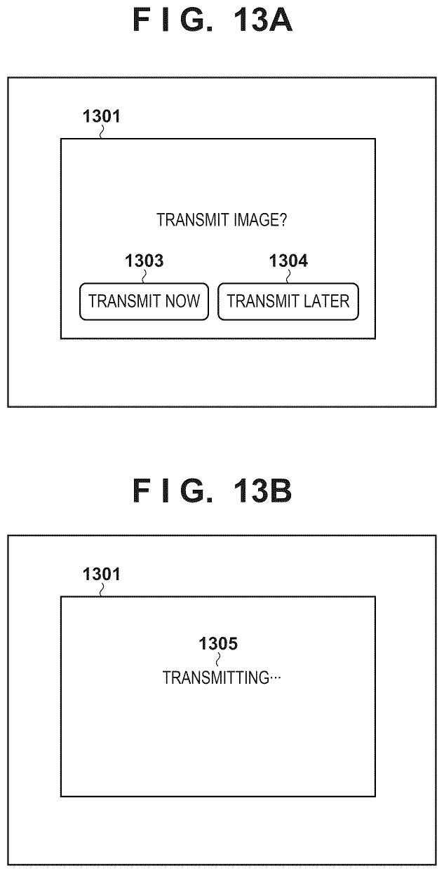

Further, the timing at which image data obtained by image capturing and associated information are transmitted is not limited to the above example. For example, after the image captured in step S305 is displayed for a predetermined time, a screen 1301 indicating a “transmit now” button 1303 for immediately transmitting the captured data and a “transmit later” button 1304 for transmitting the captured data later, as illustrated in FIG. 13A, may be displayed on the display 205. If the “transmit now” button 1303 has been pressed, the captured image and associated information are outputted to the image capturing control apparatus 106 or the image management apparatus 105 and then the processing proceeds to step S306. During transmission, an image illustrated in FIG. 13B may be displayed to notify the photographer that the transmission is in progress. Further, if the “transmit later” button 1304 has been pressed, the processing proceeds to step S306 without performing transmission, and as described above, untransmitted images are collectively transmitted at the end of image capturing.

This makes it possible to stably transmit image data, and also, by notifying the current internal processing, it is possible make the user feel reassured and reduce erroneous operations. Further, it is possible to alleviate the photographer's stress also in environments with infrastructure in which a delay occurs in the download time for each instance of image capturing due to the medical department being one where many images are captured or the network 102 having no spare bandwidth.

Further, a configuration in which image data and associated information are first displayed on the electronic medical record terminal apparatus 104 and image data to be stored is selected and then stored in the image management apparatus 105 may be taken. With such a configuration, it is possible to select and store only data that is meaningful for the doctor from a plurality of pieces of image data, and it is possible to save the search time and the storage region.

By thus changing the transmission frequency or adjusting the load on the network according to the network status of the infrastructure and circumstances of operation of hospital equipment, it is possible to facilitate image confirmation work.

Further, in the above GUI illustrated in FIG. 7B, it is assumed that the patient name 741 obtained based on the pairing information is displayed. However, a configuration in which, in a case where the connection state of the network 102 is poor and the like and the electronic medical record information cannot be obtained, a button 746 for inputting patient information and a button 747 for inputting photographer information are provided as illustrated in FIG. 7D and the information is associated with the image as associated information, individually using a read code or the like, or inputted directly using read information may be taken.

Further, by confirming the association relationship between the image of the affected part and the photographer as necessary, the photographer, for example, can be confirmed, and by recording it in the metadata region of the captured image, the state and the like at the time of image capturing can be confirmed at a later date and if the composition, brightness, and saturation of a captured image feels unnatural, the state and the like at the time of image capturing can be confirmed.

The GUIs illustrated in FIGS. 7A to 7D are only examples, and the present disclosure is not limited thereto. For example, the interface form, combination, operational restrictions, and the like for display update, arrangement, and input may be changed as necessary depending on the user's circumstances (e.g., hospital operation, circumstances, and policies) and the state of the image capturing apparatus 101. This makes it possible to increase image capturing efficiency, data operation efficiency, and system processing efficiency related to the image capturing apparatus 101 and reduce inefficient operations and processes.

Further, in actual operation, it is possible to perform more practical operation or more efficient operation by providing the following pairing conditions.
(a) A plurality of image capturing apparatuses may be paired with one electronic medical record terminal apparatus or electronic medical record application.

By thus pairing the camera IDs of a plurality of image capturing apparatuses with one terminal/application ID, in a case where a plurality of types of image capturing apparatuses (e.g., a macro lens camera, a microscope camera, a Charge Coupled Device (CCD) camera, etc.) are used in image capturing performed during an examination in which one electronic medical record is used, it is possible to transmit information on the same electronic medical record to all the cameras.
(b) One electronic medical record application is always paired with one image capturing apparatus.

Information on one electronic medical record can thus be inputted to only one image capturing apparatus, and thus, it is possible to reduce cases where metadata is inputted to a plurality of image capturing apparatuses and incorrectly associated with captured data.
(c) One image capturing apparatus cannot be paired with a plurality of electronic medical record applications.

By thus not allowing the camera ID of one image capturing apparatus to be paired with a plurality of terminal/application IDs, it is possible to prohibit information on a plurality of electronic medical records from being inputted to one image capturing apparatus, and thus, it is possible to prevent incorrect association with captured data.

By controlling pairing conditions in accordance with the operation of the actual system as described above, it is possible to promote efficient operation of devices and reduce erroneous operations, as well as hold pairing information even if the power of the image capturing apparatus 101 or electronic medical record terminal apparatus 104 is individually operated, and thus, it is possible to restore the stored pairing information when the power of the apparatus is turned on again.

Further, by updating pairing information based on the pairing conditions as described above, it is possible to update the pairing of the image capturing apparatus 101 and the electronic medical record application, and thus, it becomes easy to rearrange the combination of the image capturing apparatus 101 and the electronic medical record application to be used for the task.

Further, a configuration in which, by detecting the network 102 in advance or as necessary, the camera ID of the connected image capturing apparatus 101 and the application ID of the electronic medical record application are listed as in FIG. 11A, and at the time of pairing, it is determined whether the pair is valid simply by performing simple connection processing, presence confirmation, or the like may be taken.

This eliminates the need to search for or detect a camera on the network 102 or an electronic medical record for each pairing process, and thus, the response speed of the system is improved.

Further, in the above example, pairing information holding and input functions and metadata holding and input functions are included in the image capturing control apparatus 106, but a configuration in which input is performed from the electronic medical record terminal apparatus 104 or the electronic medical record management apparatus 103, or the functions are distributed among respective apparatuses may be taken.

Further, associated information may be inputted via the network 102 as necessary but may be stored in the image capturing apparatus 101 from the network 102 in accordance with the operation of the system to be selectable from various interfaces of the image capturing apparatus 101 to improve responsiveness and processing load. This makes it possible to perform operations suitable for the system constituting a respective hospital and workflow of the staff.

In the above example, the image capturing control apparatus 106 obtains information on the electronic medical record corresponding to the terminal/application ID from the electronic medical record management apparatus 103 and performs comparison to determine whether there has been a change in the electronic medical record being viewed using the electronic medical record application. However, the present disclosure is not limited thereto, and when a change is made to the electronic medical record, the electronic medical record terminal apparatus 104 may transmit change information and the information on the electronic medical record after the change to the image capturing control apparatus 106. In this way, it becomes unnecessary for the image capturing control apparatus 106 to retrieve the information on the electronic medical record from the electronic medical record management apparatus 103 as necessary, thereby allowing reduction in the load on the electronic medical record management apparatus 103 and the traffic on the network 102.

Further, in the above example, image capturing is ended by a press of the end button 743, but for example, a similar button may be provided on the window 901 of the electronic medical record application. Alternatively, the end of image capturing may be a specific operation (e.g., a patient switching operation, the start of input of an examination result, or when data to be stored is displayed on the above electronic medical record terminal apparatus 104 and selected) to the electronic medical record by the doctor. With this configuration, even if the operator forgets to operate the image capturing apparatus 101 or the like, it is possible to transmit the captured data seamlessly and reduce operation procedures.

Further, when the power of the image capturing apparatus used in the examination is turned off, the pairing information with the electronic medical record may be held by an external apparatus according to above method or may be cleared. This makes it possible to adjust the frequency of pairing in accordance with the operation of the image capturing apparatus (e.g., a change of the photographer, reuse of the image capturing apparatus, etc.) in the hospital, and thus, it is possible to reduce the pairing effort and prioritize privacy.

Thus, according to the present embodiment, it is possible to manage and update the pairing information based on various pairing conditions, and thus, it becomes easy to update the pairing information on the image capturing apparatus and the electronic medical record to be used in the task in accordance with task contents, purpose, operation, and the like.

Further, according to the present embodiment, a configuration may be taken in which, by setting the initial state at the time of power activation in a pairable state (pairing screen) or by storing the current pairing information at the time of power termination in the image capturing apparatus or the image capturing control apparatus so as to be able to operate the image capturing apparatus in the stored pairing state at the time of next activation, thereby allowing reduction in operation effort.

Further, according to the present embodiment, it is possible to input, confirm or update the subject and related metadata as necessary. By configuring such a function, metadata such as the name of the patient or photographer, ID of the electronic medical record, and medical treatment information, is inputted from outside the image capturing apparatus and displayed, updated, or metadata region of a captured image, related files, and the like are stored. By thus inputting to the image capturing apparatus various kinds of metadata related to image capturing at the time of image capturing and storing them in association with the captured image at the time of image capturing and by automatically organizing images of affected parts, it is possible to reduce the effort and work of organization or analyze images for each symptom, and easily observe changes over time, and thus, it makes it easy to improve efficiency in the work related to examination by the photographer, i.e., the staff, and support diagnosis.

Further, according to the present embodiment, it is possible to display or update as necessary in the user interface, such as an image capturing screen, the image capturing apparatus and which electronic medical record are paired. This makes it possible to confirm the pairing state between the image capturing apparatus and the electronic medical record, and thus, it is possible to prevent capturing an image in an unintended wireless interrupted state or while paired with an erroneous electronic medical record.

### Second Embodiment

Next, a second embodiment according to the present disclosure will be described.

In the first embodiment, a method in which identification information is used only for pairing the image capturing apparatus 101 and the electronic medical record terminal apparatus 104 and/or the electronic medical record application, with the image capturing control apparatus 106 as the performer of processing, has been described. In the second embodiment, an embodiment that is preferred in a case where the identification information includes either terminal information or person information, with the image capturing apparatus 101 as the performer of processing, will be described.

Since the configurations of the medical system and each apparatus constituting the medical system in the second embodiment are the same as that described with reference to FIGS. 1 to 5 in the first embodiment, description will be omitted here.

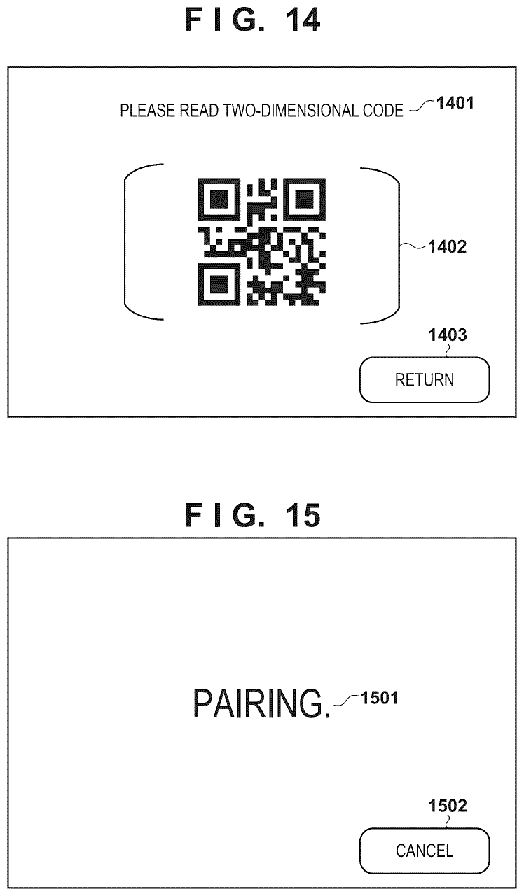

FIG. 14 is a diagram illustrating an example of a guidance screen at the time of capturing an image of a two-dimensional code, to be displayed on the display 205 of the image capturing apparatus 101. The guidance screen includes a guidance message 1401, a guide display 1402 at the time of performing scanning, and a return button 1403. The guidance message 1401 is a message for prompting the user for operation and displays, for example, text indicating “please read the two-dimensional code”. The guide display 1402 is a shape indicating a guide for a region to place the two-dimensional code in a PV image. The return button 1403 is a button for interrupting capturing an image of a two-dimensional code and returning to the original screen (e.g., one of the GUIs illustrated in FIGS. 7A to 7D). A two-dimensional code to be an image capturing target may be, for example, physically attached to the computer 902 of the electronic medical record terminal apparatus 104 as illustrated in FIG. 9A, displayed in the window 901 of the electronic medical record application as illustrated in FIG. 9B, or printed on a wristband or the like commonly used for an inpatient.

FIG. 15 is a diagram illustrating an example of a screen indicating that pairing processing is in progress, to be displayed on the display 205 of the image capturing apparatus 101. The screen indicating that pairing processing is in progress includes a message 1501 indicating the pairing state, and a cancel button 1502. The message 1501 indicating the pairing state is, for example, “pairing”, “paired”, and the like. The cancel button 1502 a button for cancelling and ending pairing.

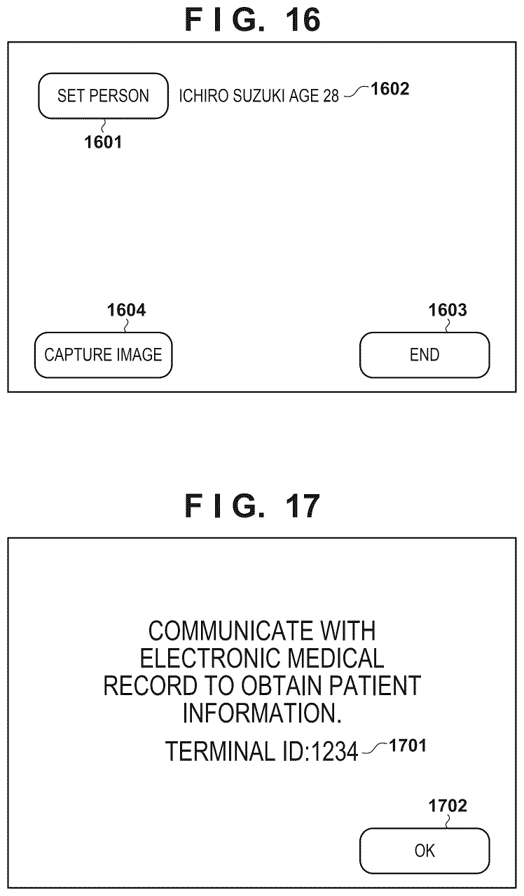

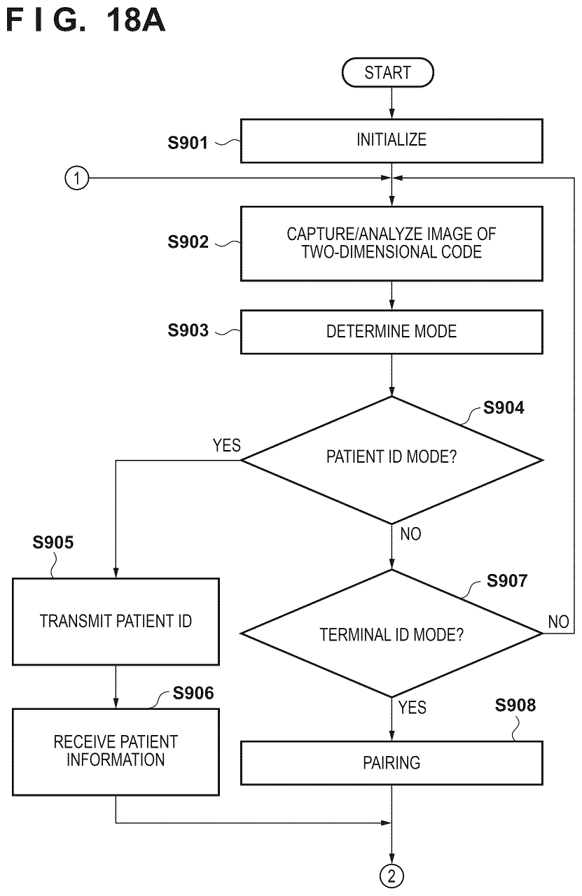

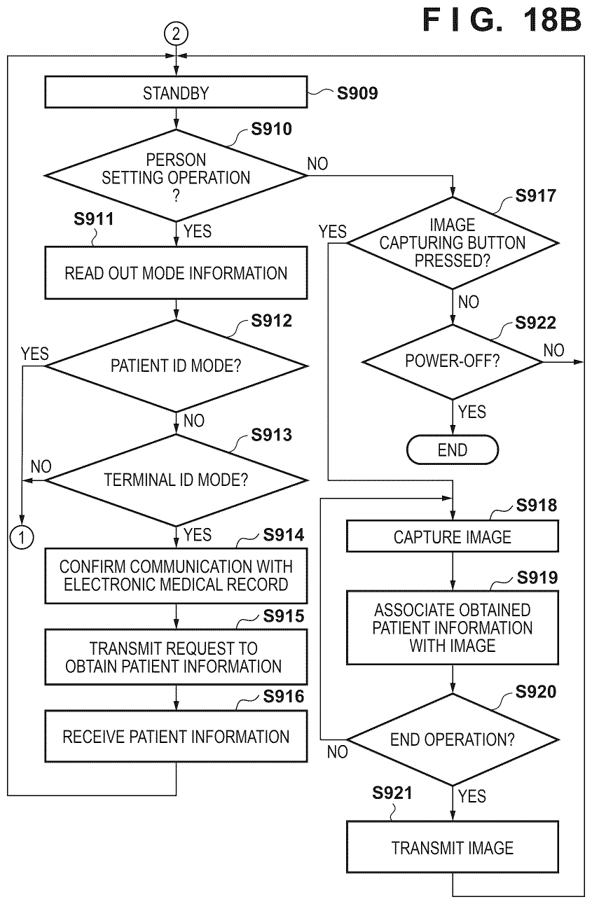

FIG. 16 is a diagram illustrating an example of a standby screen to be displayed on the display 205 of the image capturing apparatus 101 in step S909 of FIG. 18B, which will be described later. The standby screen includes a person setting button 1601, a person information display area 1602, an end button 1603, and an image capturing button 1604. The person setting button 1601 is a button for obtaining or confirming person information and performing re-setting. The person information display area 1602 is an area for displaying obtained person information. If patient information and photographer information have already been obtained, person information is displayed in the person information display area 1602. The end button 1603 is a button for ending capturing an image of an affected part. The image capturing button 1604 is a button for advancing to image capturing processing.

FIG. 17 is a diagram illustrating an example of an electronic medical record communication confirmation screen to be displayed on the display 205 of the image capturing apparatus 101. The electronic medical record communication confirmation screen includes a terminal ID information display area 1701 and an OK button 1702. The terminal ID information display area 1701 is an area for displaying the terminal ID extracted from a two-dimensional code. The OK button 1702 is a button for starting communication with the electronic medical record terminal apparatus 104.

Next, a method of obtaining person information associated with image data according to the second embodiment will be described. The person information is information related to a specific person, such as patient information and photographer information. In the present embodiment, the person information is obtained by two types of obtainment methods.

One of the methods of obtaining person information is to obtain person information associated with person identification information. The image capturing apparatus 101 receives person identification information from the user by user operation. Then, person information is obtained by obtaining person information associated with the received person identification information.

Another method of obtaining person information is to obtain person information from an external apparatus. The image capturing apparatus 101 transmits a request to obtain person information to an external apparatus. Then, person information is obtained by receiving person information transmitted from the external apparatus.

In the second embodiment, the image capturing apparatus 101 determines which of these methods is selected to obtain person information.

The image capturing apparatus 101 determines whether it is necessary to receive person identification information based on obtained information. If it is determined that it is necessary to receive person identification information, the image capturing apparatus 101 selects a method of obtaining person information using received person identification information and receives person identification information by user operation. If the image capturing apparatus 101 determines that it is not necessary to receive person identification information, the image capturing apparatus 101 selects a method in which person information is obtained from an external apparatus. The image capturing apparatus 101 obtains person information to be associated with image data in accordance with the selected method.

Next, a series of processes in which the CPU 201 of the image capturing apparatus 101 obtains patient information as an example of person information and associates it with image data will be described in detail with reference to a flowchart of FIGS. 18A and 18B.

Upon a power-on by the power switch 262 or an instruction to release the sleep state, in step S901 the CPU 201 of the image capturing apparatus 101 executes initialization processing. The initialization processing includes various kinds of execution processing to be performed initially, such as an initial setting of the system and recorded information readout processing. The initialization processing may also be configured to be executed, for example, when a start button is displayed on the display 205 of the image capturing apparatus 101 and a press of the start button is accepted by user operation or when the image capturing apparatus 101 enters a specific state. Upon detecting completion of the initialization processing, the CPU 201 advances the processing to step S902.

In step S902, the CPU 201 performs two-dimensional code image capturing/analysis processing. In the two-dimensional code image capturing/analysis processing, first, a guidance screen for capturing an image of a two-dimensional code as illustrated in FIG. 14 is displayed on the display 205. The guidance screen for two-dimensional code image capturing is a screen prompting the user to capture an image of a two-dimensional code. Then, capturing of an image of the two-dimensional code by the user is accepted. Then, upon detection that an image of a two-dimensional code has been captured by a press or the like of the shutter button 261, the captured two-dimensional code image is analyzed, and character string information included in the two-dimensional code is extracted.

The character string information includes ID information and attribute information. The character string information is constituted by alphanumeric characters. The ID information is person identification information for identifying a respective patient, terminal, and the like. The attribute information is information indicating what the attribute of the ID information is. For example, if the character string information is “patient ID: 12345”, the “patient” portion is the attribute information and the “12345” portion is the ID information. Hereinafter, the character string information in which the attribute information is a patient is referred to as “patient ID”, and the character string information in which the attribute information is a terminal is referred to as “terminal ID”. Upon completion of the two-dimensional code image capturing/analysis processing, the processing proceeds to step S903.

In step S903, the CPU 201 executes mode determination processing. The mode determination processing determines a patient ID mode or a terminal ID mode based on the extracted character string information. Specifically, determination is made based on whether the character string information includes a specific character string. For example, when the character string information includes a character string of “patient ID:”, it is determined to operate in the patient ID mode, and when the character string information includes a character string of “terminal ID:”, it is determined to operate in the terminal ID mode. The patient ID mode and the terminal ID mode need only be distinguished, and any predetermined keyword may be used. Alternatively, the mode may be determined based on the number of characters in the character string information and whether a specific character is included.

As the mode determination processing, whether the determined mode is the patient ID mode or the terminal ID mode is stored as the mode information in a storage region, such as the memory 202. The value of the mode information stored in the storage region is deleted when the power is turned off or the reset processing is executed. Upon completion of the mode determination processing, the processing proceeds to step S904.

In step S904, the CPU 201 determines whether the result of the mode determination processing in step S903 is the patient ID mode. If it is the patient ID mode, the processing proceeds to step S905, and if it is not the patient ID mode, the processing proceeds to step S907.

In step S905, the CPU 201 transmits the patient ID to the image capturing control apparatus 106 via the network 102 and transmits a request to obtain patient information corresponding to the transmitted patient ID. At this time, the CPU 201 displays on the display 205 a screen indicating that the patient information is being obtained. In the image capturing control apparatus 106, the patient ID and the patient information are stored in association with each other. The CPU 301 of the image capturing control apparatus 106 identifies patient information associated with the patient ID received from the image capturing apparatus 101 and transmits the identified patient information to the image capturing apparatus 101 via the network 102.

In step S906, the CPU 201 receives patient information from the image capturing control apparatus 106 as processing for obtaining patient information that involves transmitting a patient ID, displays the received patient information on the display 205, and advances the processing to standby processing of step S909. At this time, the screen as illustrated in FIG. 16 is displayed.

Meanwhile, in step S904, if it is determined not to be the patient ID mode, in step S907 the CPU 201 determines whether it is the terminal ID mode. If it is the terminal ID mode, the processing proceeds to step S908, and if it is not the terminal ID mode, the processing returns to step S902, and the two-dimensional code image capturing/analysis processing is performed again.

In step S908, the CPU 201 executes pairing processing. The CPU 201 performs pairing of the image capturing apparatus 101 and the electronic medical record terminal apparatus 104 as the pairing processing. The CPU 201 transmits a request to pair the camera ID of the image capturing apparatus 101 and the terminal ID to the image capturing control apparatus 106 via the network 102. The CPU 301 of the image capturing control apparatus 106 pairs the image capturing apparatus 101 and the electronic medical record terminal apparatus 104 based on the camera ID and the terminal ID received from the image capturing apparatus 101. The camera ID includes information identifying the image capturing apparatus 101, and the terminal ID includes information identifying the terminal to be paired. By pairing, the image capturing apparatus 101 and the image capturing control apparatus 106 determine the electronic medical record terminal apparatus 104 with which to communicate. During pairing, the CPU 201 displays on the display 205 the screen indicating that pairing processing is in progress illustrated in FIG. 15.

Upon receiving a pairing completion notification from the image capturing control apparatus 106 via the network 102, the CPU 201 displays on the display 205 a message indicating that pairing has been completed. After displaying the message indicating that the pairing has been completed, the CPU 201 displays the standby screen as illustrated in FIG. 16 on the display 205. However, in the terminal ID mode, person information has not been obtained at this point, and thus, display in the person information display area 1602 is not performed. The ID information of the paired electronic medical record terminal apparatus 104 may be displayed instead of the person information.

In step S909, the CPU 201 executes standby processing. The CPU 201 enters a state in which it can accept an operation from the user as the standby processing. The CPU 201 displays the standby screen on the display 205. The CPU 201 accepts an operation from the user on the standby screen.

In step S910, the CPU 201 determines whether the operation received from the user is an operation of pressing the person setting button 1601. If it is an operation of pressing the person setting button 1601, the processing proceeds to step S911, and if it is not an operation of pressing the person setting button, the processing proceeds to step S917.

In step S911, the CPU 201 reads out the mode information stored in a storage region, such as the memory 202, in step S903.

In step S912, the CPU 201 determines whether the readout mode information is the patient ID mode. If it is the patient ID mode, the processing returns to the two-dimensional code image capturing/analysis processing of step S902, and if it is not the patient ID mode, the processing proceeds to step S913.

In step S913, the CPU 201 determines whether the readout mode information is the terminal ID mode. If it is the terminal ID mode, the processing proceeds to step S914, and if it is not the terminal ID mode, the processing returns to the two-dimensional code image capturing/analysis processing of step S902. Further, a configuration in which, if the mode information is not recorded, the two-dimensional code image capturing/analysis processing of step S902 is also returned to may be taken.

In step S914, the CPU 201 displays an electronic medical record communication confirmation screen as illustrated in FIG. 17 on the display 205. The CPU 201 accepts an operation of pressing the OK button 1702 from the user on the electronic medical record communication confirmation screen. Upon a press of the OK button 1702, the processing proceeds to step S915.

In step S915, the CPU 201 transmits a request to obtain patient information as processing for obtaining patient information that does not involve transmitting patient ID. At this time, instead of the patient ID, the terminal ID which is paired with the image capturing apparatus 101, or the camera ID of the image capturing apparatus 101 is transmitted. While obtaining patient information, the CPU 201 displays a patient information obtainment in-progress screen on the display 205. In response to the request to obtain patient information received from the image capturing apparatus 101, the CPU 301 of the image capturing control apparatus 106 transfers the request to obtain patient information to the electronic medical record terminal apparatus 104, which is paired with the image capturing apparatus 101. In response to the received request to obtain patient information, the electronic medical record terminal apparatus 104 obtains unique patient information from the electronic medical record and transmits it to the image capturing control apparatus 106. The CPU 301 of the image capturing control apparatus 106 transfers the patient information received from the electronic medical record terminal apparatus 104 to the image capturing apparatus 101.

In step S916, upon receiving the patient information from the image capturing control apparatus 106 as processing for obtaining patient information that does not involve transmitting patient ID, the CPU 201 returns to step S909, displays the standby screen illustrated in FIG. 16 on the display 205, and displays the received patient information in the person information display area 1602.

If the operation received from the user in step S910 is not an operation of pressing the person setting button 1601, in step S917 the CPU 201 determines whether the operation received from the user is an operation of pressing the image capturing button 1604. If it is an operation of pressing the image capturing button 1604, the processing proceeds to step S918, and if it is not an operation of pressing the image capturing button 1604, the processing proceeds to step S922.

In step S918, the CPU 201 captures an image in response to an operation of pressing the shutter button 261. Capturing of an image may be capturing of an image of an affected part or any image to be recorded in association with patient information. For example, an image of the entire body or a normal part of the patient or surrounding environment may be captured. The captured image is stored in the recording medium 208.

In step S919, the CPU 201 associates the obtained patient information with the image captured in step S918. Here, association is performed by writing patient information in the Exif information of the image. The CPU 201 displays the captured image on the display 205 and displays an end button for instructing the end of image capturing.

In step S920, the CPU 201 determines whether the user has performed an operation of pressing the end button. If an operation of pressing the end button has been performed, the processing proceeds to step S921, and if an operation of pressing the end button has not been performed, the processing proceeds to step S918. The image capturing processing and the association processing are repeated a desired number of times.

In step S921, the CPU 201 transmits the image with which the patient information has been associated and which is stored in the recording medium 208 to the image capturing control apparatus 106 via the network 102.

If it is determined not to be an operation of pressing the image capturing button 1604 in step S917, in step S922 the CPU 201 determines whether the operation received from the user is a power-off operation. Here, an operation of pressing the end button 1603 or a power-off operation by the power switch 262 is detected. If it is not a power-off operation, the processing proceeds to step S909, and if it is a power-off operation, the processing ends. At this time, the CPU 201 deletes the stored patient information. The present disclosure is not limited to the stored patient information being deleted at the time of power-off and the stored patient information may be deleted in accordance with completion of transmission of the image with which the patient information has been associated in step S921.

With the above configuration, the image capturing apparatus 101 automatically determines and selects a plurality of person information obtainment methods without selection by the user, thereby reducing user effort.

Further, by acting to receive person identification information by user operation only when person identification information is necessary, it is possible to omit user operation when person identification information is not necessary, which makes it possible to reduce user effort.

Further, it is possible for one image capturing apparatus 101 to support a plurality of person information obtainment methods, and it becomes unnecessary to prepare a separate image capturing apparatus 101 for each mode.

Further, in the configuration according to the present embodiment, it is possible for the user to obtain person information by similar operation procedures in the plurality of person information acquisition methods. By there being many common parts in operation procedures, the user will not be confused with the operation, and thus, the usability is improved.

Further, by displaying the electronic medical record communication confirmation screen, it is possible to give the user time to perform the next operation on the image capturing apparatus 101 after the user performs a preparation operation to be able to obtain patient information on the electronic medical record terminal apparatus 104, thereby improving usability.

Although a configuration in which the two-dimensional code image capturing/analysis processing is executed in response to execution of the initialization processing has been taken, a configuration in which the two-dimensional code image capturing/analysis processing is executed under another condition may be taken. For example, in a standby processing state, the image capturing apparatus 101 may display a two-dimensional code image capturing start button on the display 205 and, upon receiving a press of a button by the user, execute the two-dimensional code image capturing/analysis processing.

In the above example, a configuration in which in step S902 the image capturing apparatus 101 performs image capturing and analysis of a two-dimensional code and extracts character string information has been taken, but analysis may be performed by something other than the image capturing apparatus 101. For example, a configuration in which the image capturing apparatus 101 transmits the captured image of a two-dimensional code to the image capturing control apparatus 106, the captured image is analyzed by the image capturing control apparatus 106, and the image capturing apparatus 101 receives the extracted character string information from the image capturing control apparatus 106 may be taken. Further, the present configuration is a configuration in which the series of processes is performed in the image capturing apparatus 101, but a configuration in which processing is performed in external apparatuses including the image capturing control apparatus 106 as a series of systems may be taken.

Further, a configuration in which patient information is received from the image capturing control apparatus 106 in the processing in which patient information is obtained using patient ID information has been taken, but another configuration may be taken. For example, patient information may be received from an apparatus other than the image capturing control apparatus 106 via the network 102. Further, patient information may be obtained in the image capturing apparatus 101 without going through the network 102. For example, in the two-dimensional code image capturing/analysis processing, character string information included in a two-dimensional code may include patient information, in which case the patient information included in the character string information is used as is. In this case, the patient information can be obtained without transmitting the patient ID via the network 102.

Further, in the above example, it is assumed that the terminal ID of the electronic medical record terminal apparatus 104 and the camera ID of the image capturing apparatus 101 are paired and stored, but as described in the first embodiment, the ID of the electronic medical record application activated on the electronic medical record terminal apparatus 104 may be paired.

Further, in the above example, description has been given assuming that the image capturing control apparatus 106 obtains patient information from the electronic medical record terminal apparatus 104, but as described in the first embodiment, a configuration in which it is obtained from the electronic medical record management apparatus 103 may be taken.

### Third Embodiment

Next, a third embodiment according to the present disclosure will be described.

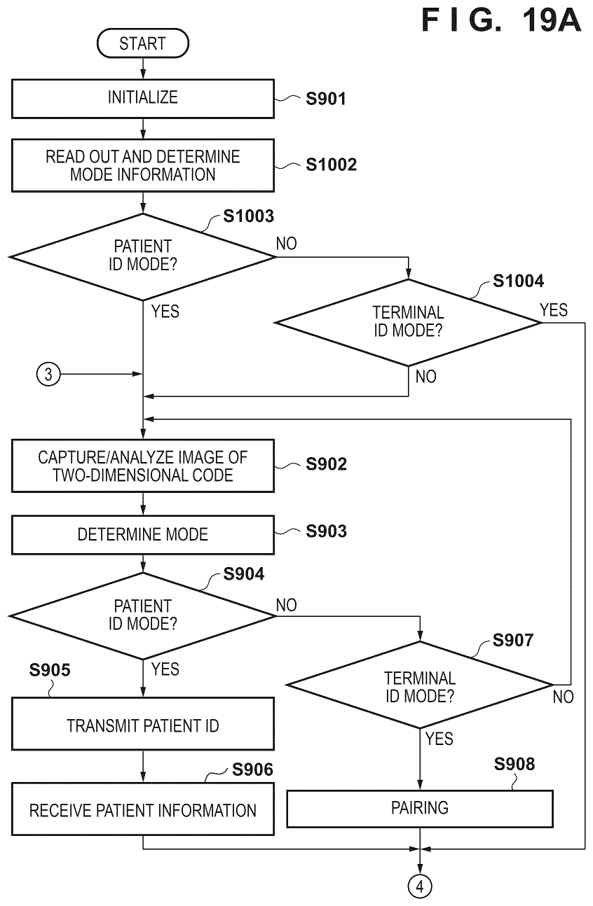

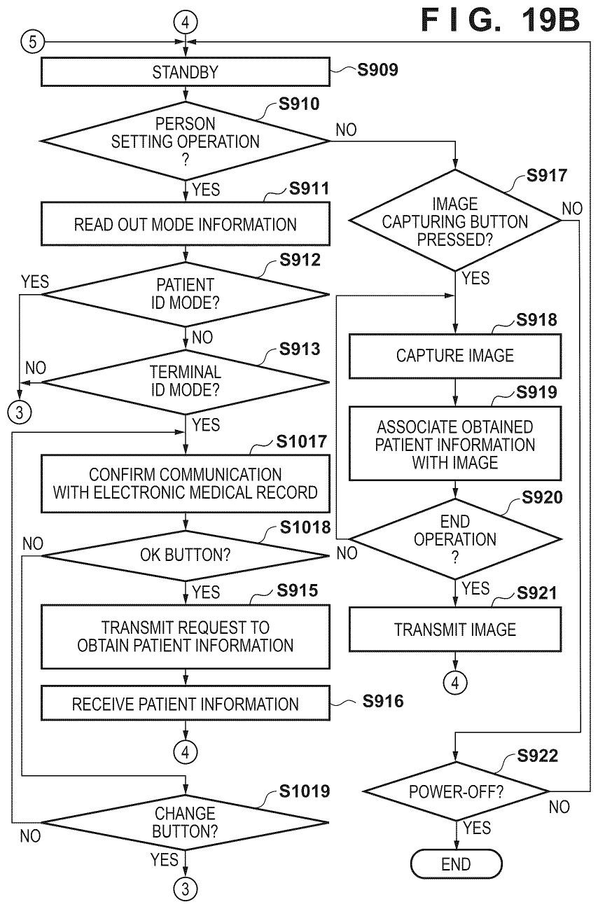

In the above second embodiment, a configuration in which mode information is recorded in the memory 202 has been described as an example. Therefore, the stored value of the mode information is deleted by a power-off. In contrast, in the third embodiment, a series of processes that include processing for storing mode information in the non-volatile memory 203 or the recording medium 208 will be described in detail with reference to a flowchart illustrated in FIGS. 19A and 19B. The value of the mode information is stored in the non-volatile memory 203 or the recording medium 208 and is thus not deleted even upon a power-off. In FIGS. 19A and 19B, the same reference numerals are given to the same processes as the processes of the flowchart illustrated in FIGS. 18A and 18B, and thus, description will be omitted as appropriate.

Upon completion of initialization in step S901, in step S1002 the CPU 201 reads out mode information from the non-volatile memory 203 or the recording medium 208.

In step S1003, the CPU 201 determines whether the mode information read out in step S1002 is the patient ID mode. If it is the patient ID mode, the processing returns to the two-dimensional code image capturing/analysis processing of step S902, and if it is not the patient ID mode, the processing proceeds to step S1004.

In step S1004, the CPU 201 determines whether the readout mode information is the terminal ID mode. If it is the terminal ID mode, the processing proceeds to the standby processing of step S909, and if it is not the terminal ID mode, the processing proceeds to the two-dimensional code image capturing/analysis processing of step S902. Further, a configuration in which, if mode information is not recorded, the processing also proceeds to step S902 may be taken.

The processing from steps S902 to S913 is as described above in the second embodiment.

In the processing of step S913, if it is determined that it is the terminal ID mode, in step S1017 the CPU 201 displays the electronic medical record communication confirmation screen on the display 205. In the third embodiment, it is assumed that a change button is added to the electronic medical record communication confirmation screen as illustrated in FIG. 17. The change button is a button for changing the mode information or ID information.

In step S1018, the CPU 201 determines whether the operation received from the user is an operation of pressing the OK button 806. If it is an operation of pressing the OK button 802, the processing proceeds to step S915, and if it is not an operation of pressing the OK button 802, the processing proceeds to step S1019.

In step S1019, the CPU 201 determines whether the operation received from the user is an operation of pressing the change button. If it is an operation of pressing the change button, the processing proceeds to the two-dimensional code image capturing/analysis processing of step S902, and if it is not an operation of pressing the change button, the processing returns to step S1017.

In the two-dimensional code image capturing/analysis processing, if an image of a two-dimensional code indicating a patient ID is captured, the patient ID mode is stored as the mode information. Since the configuration is such that the mode information is held even if the power is turned off, it is necessary to allow a change of the mode information. Therefore, if the user desires to switch from the terminal ID mode to the patient ID mode, they can perform the switch by pressing the change button. With this, the image capturing apparatus 101 operates by switching the mode from the terminal ID mode to the patient ID mode.

Further, in the two-dimensional code image capturing/analysis processing, if an image of a two-dimensional code indicating a terminal ID is captured, it is possible to perform pairing processing with a new terminal based on a new terminal ID.

The processing from steps S917 to S922 is as described above in the second embodiment.

As described above, according to the third embodiment, if the value of the mode information is the terminal ID mode, since the pairing processing has already been executed, it is unnecessary to execute the pairing processing each time at power-on. This makes it possible to omit execution of the two-dimensional code image capturing/analysis processing and reduce user effort for operation.

### Other Embodiments

In the above second and third embodiments, mode determination processing is performed based on character string information obtained by analyzing captured two-dimensional code. However, it is not limited to captured two-dimensional code information and may be any information obtained by the system. For example, mode determination processing may be executed based on access point information. The access point information is information related to an access point to which the image capturing apparatus 101 connects when wirelessly connecting to the network 102. More specifically, the image capturing apparatus 101 executes wireless connection processing. The wireless connection processing may be executed as initialization processing at power-on, or the processing may be started by an operation from the user. As the wireless connection processing, the image capturing apparatus 101 obtains connection destination access point information. Then, the image capturing apparatus 101 transmits the obtained access point information to the image capturing control apparatus 106. The image capturing control apparatus 106 identifies mode information associated with the received access point information from table information in which the access point information and the mode information are associated with each other and transmits the mode information to the image capturing apparatus 101. The image capturing apparatus 101 determines the mode information from the image capturing control apparatus 106. The mode determination processing is thus executed based on access point information.

For example, if the image capturing apparatus 101 is being used in a particular area, the system identifies that area based on the access point information and automatically selects an appropriate mode. This process causes the image capturing apparatus 101 to operate in a mode suitable for the area even when moved to a different area. That is, the camera can operate in a mode suitable for the environment in which it is used.

Furthermore, a configuration for allowing mode switching when the image capturing apparatus 101 determines that there is a possibility of mode switching may be taken. Conditions for determining that there is a possibility of mode switching are as follows.

First, an example in which, when a change in access point information is detected, it is determined that a mode switching possibility condition has been met will be described. When the image capturing apparatus 101 moves to a different area, connection destination access point is changed, and the image capturing apparatus 101 detects a change in access point information. Upon detection of a change in access point information, a table in which access point information and mode information are associated with each other is searched again and new mode information is obtained. Then, comparison with the stored mode information is performed, and if not a match, it is determined that the mode switching possibility condition has been met.

Here, a configuration in which a table in which access point information and mode information are associated with each other is used has been taken, but another configuration may be taken. For example, a configuration in which a table in which access point information and installation area information are associated with each other is used may be taken. The installation area information is information related to an area in which an access point is installed. For example, there are “Building A, 2nd Floor”, “Building B, 3rd Floor”, and the like as installation areas. In this case, the installation area information is derived from access point information. Even if the connection destination access point is changed, if the installation area is in the same building, it is possible to determine that the mode switching possibility condition has not been met. This makes it possible to exclude a case where the access point is changed in the same installation area, which has the effect of not displaying an unnecessary mode switch to the user.

Next, an example in which, when a change in Global Positioning System (GPS) position information of the image capturing apparatus 101 is detected, it is determined that the mode switching possibility condition has been met will be described. The image capturing apparatus 101 obtains GPS position information. The image capturing apparatus 101 itself may include a GPS function or may receive position information from an external apparatus that includes a GPS function. The GPS position information, which is changed by the image capturing apparatus 101 being carried around, is changed. When the amount of change in position information exceeds a threshold of the amount of change defined in advance, it is determined that the mode switching possibility condition has been met.

A change in access point information and GPS position information suggests that the image capturing apparatus 101 has been carried around and the usage of the image capturing apparatus 101 may change, and thus, it is determined that the mode may be switched.

Next, an example in which, when it is detected that a predetermined time has elapsed from reception of an end operation, it is determined that the mode switching possibility condition has been met will be described. The image capturing apparatus 101 stores a time at which a press of the end button from the user has been received. Then, when the time elapsed from the stored time exceeds a time threshold defined in advance, it is determined that the mode switching possibility condition has been met. It can be considered that the user is likely to continue usage in the same mode until they are done with a series of processes.

Next, an example in which, when it is detected that the user has logged out from the electronic medical record, it is determined that the mode switching possibility condition has been met will be described. It is assumed that the electronic medical record is used by the user in a login state while attending to a patient and the user logs out from the electronic medical record when they finish attending to the patient. It can be considered that the user is likely to switch the mode and operate in another mode when they finish attending to the patient. The information that the user wants to log out from the electronic medical record is received by the image capturing apparatus 101 from the electronic medical record terminal apparatus 104 via the network 102. In addition, when the image capturing apparatus 101 is in the standby processing, it is determined that the mode switching possibility condition has been met. It can be considered that, if not in the standby processing, the user is operating the image capturing apparatus 101 and is less likely to perform mode switching.

Next, an example in which, when it is detected that an image of a two-dimensional code has been captured in the standby processing, it is determined that the mode switching possibility condition has been met will be described. Upon capturing an image of a two-dimensional code in the standby state, the image capturing apparatus 101 executes the mode determination processing and performs comparison with stored mode information and if not a match, it is determined that the mode switching possibility condition has been met. The present disclosure is not limited to two-dimensional code image capturing in the standby processing, and when the user detects a different operation from what is normal, it may be determined that the mode switching possibility condition has been met.

Further, a method of allowing mode switching includes the following.

First, an example of allowing mode switching by displaying a mode change button on the display 205 will be described. The image capturing apparatus 101 displays a change button for changing the mode on the display 205. By displaying a button without automatically switching the mode, it is possible to entrust the user with the decision to switch the mode. The processing for hiding a displayed mode change button is performed when an operation of pressing the person setting button from the user is accepted. This is because the user has started a series of image capturing processes and there is no more possibility that a mode change may be performed, and thus, a button that interferes with user operation is hidden, thereby improving user operability.

Further a configuration in which, when a notification from the outside is received, the mode change button is hidden may be taken. For example, there is a case where the image capturing control apparatus 106 receives from the electronic medical record terminal apparatus 104 with which it is in communication a notification that the same person as a previous user logged into the electronic medical record. In this case, the same person using the same terminal is likely to continue usage in the same mode, and thus, by not displaying the button, it is possible to reduce the user's confusion about the operation.

Next, an example of allowing mode switching by executing mode reset processing will be described. The mode reset processing includes processing for deleting the value of the stored mode information. If the mode information is not stored, the mode information determination processing is executed again, thereby allowing mode switching.

Next, an example of allowing mode switching by executing automatic mode switching processing will be described. Among the above processes for determining that the mode switching possibility condition has been met, there is one by which the switching destination of the mode information can be inferred. For example, in a case of a change in access point information, corresponding mode information can be identified from the access point information after the change. At this time, if the value of the mode information is updated with the identified value without executing two-dimensional code image capturing processing or mode information determination processing, the mode is switched automatically. This has the effect of reducing operation steps and thus improving the user's usability.

Further, in the above embodiments, a configuration in which standby processing is executed after pairing processing is completed has been taken, but another configuration may be taken. For example, a configuration in which, after pairing processing is completed, if patient information is in an obtainable state, standby processing is not executed and electronic medical record communication confirmation processing is executed may be taken. The patient information being in an obtainable state is a case where the image capturing control apparatus 106 detects that the electronic medical record is activated in the electronic medical record terminal apparatus 104 in communication with the image capturing control apparatus 106. This has the effect of reducing operation steps and thus improving the user's usability.

Further, in the above embodiments, a configuration in which a request to obtain patient information is made from the image capturing apparatus 101 has been taken, but another configuration may be taken. For example, a configuration in which an obtainment request is not issued from the image capturing apparatus 101 and person information is transmitted from the image capturing control apparatus 106 may be taken. In that case, regarding display of the obtained patient information on the display 205, display is deferred until the image capturing apparatus 101 executes the standby processing. This has the effect of preventing the user's work from being interrupted due to a sudden screen transition during capturing an image of another patient.

Further, in a case of a configuration in which information needs to be obtained also for photographer information, it need not be a patient ID, but may be person ID information including a photographer ID, that is captured in the two-dimensional code image capturing processing. The photographer information is information including a photographer name, photographer ID information, and the like. In particular, ID information when the attribute information is the photographer ID is called the photographer ID information. In a case of a configuration in which information needs to be obtained also for photographer information, after the person information of the first person is received, the two-dimensional code image capturing processing is executed again. This makes it possible to obtain person information for two people, who are the patient and the photographer.

Further, in the above embodiments, a configuration in which the patient ID information and photographer ID information are obtained by capturing images of two-dimensional codes has been taken, but another configuration may be taken. For example, a configuration in which an image of the face of a person is captured and person information is obtained based on that face image may be taken. Further, it is not limited to capturing an image, and a configuration in which recognition information is read from a tag by using radio frequencies, such as RFID, may be taken. In this case, a configuration in which patient ID information and photographer ID information are obtained as recognition information is formed.

Further, a configuration in which, when information obtained by the image capturing system is person identification information, person information associated with the person identification information is obtained has been taken, but another configuration may be taken. For example, a configuration in which, in the two-dimensional code image capturing processing, if information extracted from the captured image is not person identification information but is person information, processing is performed directly using that person information as obtained information may be taken.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-105478, filed Jun. 28, 2024 which is hereby incorporated by reference herein in its entirety.

What is claimed is:

1. A control apparatus comprising one or more processors which function as:
a first obtaining unit that obtains, from an image capturing apparatus connected via a communication unit, first identification information of the image capturing apparatus, and information obtained by the image capturing apparatus and related to second identification information of at least one of a terminal apparatus on which information on a management target can be viewed and an application activated on the terminal apparatus and for viewing the information on the management target;
a second obtaining unit that obtains, from a management apparatus of the management target via the communication unit, the information on the management target corresponding to the second identification information;
a storage unit that stores first identification information and the second identification information in association with each other; and
a control unit that, in a case where the information on the management target being viewed in the terminal apparatus corresponding to the second identification information has been changed, performs control to transmit, to the image capturing apparatus associated with the second identification information, the information on the management target corresponding to the second identification information that has been newly obtained from the management apparatus.

2. The control apparatus according to claim 1, wherein
the storage unit further stores the information on the management target corresponding to the second identification information in association with the second identification information,
in a case where the information on the management target corresponding to the second identification information that has been newly obtained from management apparatus and the information on the management target corresponding to the second identification information stored in the storage unit are different, the control unit determines that the information on the management target has been changed, and
in a case where it is determined that the information on the management target has been changed, the storage unit stores the information on the management target that has been newly obtained.

3. The control apparatus according to claim 1, wherein
in a case where information indicating that the information on the management target has been changed is obtained from the terminal apparatus, the control unit determines that the information on the management target has been changed.

4. The control apparatus according to claim 1, wherein
the information related to the second identification information is an image indicating the second identification information, the first obtaining unit analyzes the image and obtains the second identification information, and
the control unit transmits the second identification information to the image capturing apparatus.

5. The control apparatus according to claim 1, further comprising:
a determination unit that determines a usage status of the terminal apparatus corresponding to the second identification information,
wherein the control unit transmits the usage status to the image capturing apparatus associated with the second identification information.

6. The control apparatus according to claim 1, further comprising:
a management unit that manages association between the first identification information and the second identification information stored in the storage unit.

7. The control apparatus according to claim 6, wherein
the management unit performs management such that one terminal apparatus or application is associated with one image capturing apparatus.

8. The control apparatus according to claim 6, wherein
the management unit performs management such that one or more image capturing apparatuses are associated with one terminal apparatus or application.

9. The control apparatus according to claim 6, wherein
the management unit performs management such that a plurality of terminal apparatuses or applications are not associated with one image capturing apparatus.

10. The control apparatus according to claim 1, wherein
in a case where the information on the management target being viewed in the terminal apparatus corresponding to the second identification information could not be obtained, the control unit performs control to generate tentative information on the management target and transmit the tentative information on the management target to the image capturing apparatus.

11. The control apparatus according to claim 1, wherein
the information on the management target includes patient information or photographer information.

12. An image capturing apparatus comprising:
an image capturing unit that captures an image; and
one or more processors which function as:
an obtaining unit that obtains information related to first identification information of at least one of a terminal apparatus on which information on a management target can be viewed and an application activated on the terminal apparatus and for viewing information on a management target;
a transmission unit that transmits, to a control apparatus connected via a communication unit, the information related to the first identification information and second identification information of the image capturing apparatus;
a reception unit that receives, from the control apparatus, information on a management target corresponding to the first identification information; and
a processing unit that attaches the information on the management target to image data of the image captured by the image capturing unit.

13. The image capturing apparatus according to claim 12, wherein
the obtaining unit analyzes an image obtained by the image capturing unit capturing an image indicating the first identification information and obtains the first identification information, and
the transmission unit transmits the obtained first identification information to the control apparatus.

14. The image capturing apparatus according to claim 12, wherein
the obtaining unit obtains an image obtained by the image capturing unit capturing an image indicating the first identification information, and
the transmission unit transmits the image to the control apparatus.

15. The image capturing apparatus according to claim 12, wherein
when capturing an image indicating the first identification information, the image capturing unit captures the image by using an image capturing parameter decided in advance.

16. The image capturing apparatus according to claim 12, wherein
the obtaining unit obtains the first identification information by using at least one of an IC tag, RFID, or Bluetooth.

17. The image capturing apparatus according to claim 12,
wherein the reception unit further obtains a usage status of the terminal apparatus from the control apparatus, and
further comprising: a control unit that performs control to, in a case where the terminal apparatus is not in use, prioritize power saving processing and, in a case where the terminal apparatus is in use, not prioritize the power saving processing.

18. The image capturing apparatus according to claim 12, further comprising:
a storage unit that stores the first identification information and the second identification information in association with each other.

19. The image capturing apparatus according to claim 12, further comprising:
a display control unit that performs control to display the first identification information on the display unit.

20. The image capturing apparatus according to claim 19, wherein
the display control unit displays an instruction for instructing the obtaining unit to obtain the first identification information.

21. The image capturing apparatus according to claim 20, wherein
the display control unit does not display the instruction while the image capturing unit is capturing an image or during transmission of the captured image.

22. The image capturing apparatus according to claim 19, wherein
the display control unit performs, on the display unit, display for selecting a timing for transmitting the image to which the information on the management target has been attached by the processing unit.

23. The image capturing apparatus according to claim 12, wherein,
the information on the management target includes patient information or photographer information.

24. A system comprising:
a control apparatus comprising one or more processors which function as:
a first obtaining unit that obtains, from an image capturing apparatus connected via a communication unit, first identification information of the image capturing apparatus, and information obtained by the image capturing apparatus and related to second identification information of at least one of a terminal apparatus on which information on a management target can be viewed and an application activated on the terminal apparatus and for viewing the information on the management target;
a second obtaining unit that obtains, from a management apparatus of the management target via the communication unit, the information on the management target corresponding to the second identification information;
a storage unit that stores first identification information and the second identification information in association with each other; and
a control unit that, in a case where the information on the management target being viewed in the terminal apparatus corresponding to the second identification information has been changed, performs control to transmit, to the image capturing apparatus associated with the second identification information, the information on the management target corresponding to the second identification information that has been newly obtained from the management apparatus,
an image capturing apparatus comprising:
an image capturing unit that captures an image; and
one or more processors which function as:
an obtaining unit that obtains information related to first identification information of at least one of a terminal apparatus on which information on a management target can be viewed and an application activated on the terminal apparatus and for viewing information on a management target;
a transmission unit that transmits, to a control apparatus connected via a communication unit, the information related to the first identification information and second identification information of the image capturing apparatus;
a reception unit that receives, from the control apparatus, information on a management target corresponding to the first identification information; and
a processing unit that attaches the information on the management target to image data of the image captured by the image capturing unit,
the terminal apparatus; and
the management apparatus.

25. A control method comprising:
obtaining, from an image capturing apparatus connected via a communication unit, first identification information of the image capturing apparatus, and information obtained by the image capturing apparatus and related to second identification information of at least one of a terminal apparatus on which information on a management target can be viewed and an application activated on the terminal apparatus and for viewing the information on the management target;
obtaining, from a management apparatus of a management target via the communication unit, information on the management target corresponding to the second identification information;
storing first identification information and the second identification information in association with each other; and
in a case where the information on the management target being viewed in the terminal apparatus corresponding to the second identification information has been changed, transmitting, to the image capturing apparatus associated with the second identification information, the information on the management target corresponding to the second identification information that has been newly obtained from the management apparatus.

26. A method of controlling an image capturing apparatus, the method comprising:
obtaining information related to first identification information of at least one of a terminal apparatus on which information on a management target can be viewed and an application activated on the terminal apparatus and for viewing information on a management target;
transmitting, to a control apparatus connected via a communication unit, the information related to the first identification information and second identification information of the image capturing apparatus;
receiving, from the control apparatus, information on a management target corresponding to the first identification information; and
attaching the information on the management target to image data of the image captured by the image capturing unit.

27. An image capturing apparatus comprising:
an image capturing unit that captures an image; and
one or more processors which function as:
an obtaining unit that obtains mode information;
a switching unit, based on the mode information, that switches between a first mode in which first identification information indicating a management target is transmitted to a control apparatus and a second mode in which second identification information indicating at least one of a terminal apparatus on which information on the management target can be viewed and an application activated on the terminal apparatus and for viewing the information on the management target is transmitted to the control apparatus;
a transmission unit, in a case of the first mode, that transmits the first identification information to a control apparatus connected via a communication unit and, in a case of the second mode, transmits the second identification information to the control apparatus;
a reception unit receives, from the control apparatus, information on a management target corresponding to the first identification information or the second identification information; and
a processing unit that attaches the information on the management target to image data of the image captured by the image capturing unit.

28. The image capturing apparatus according to claim 27, wherein
the obtaining unit analyzes image data obtained by the image capturing unit capturing an image including the mode information and obtains the mode information.

29. The image capturing apparatus according to claim 28, wherein
the image including the mode information is a one-dimensional or two-dimensional code.

30. The image capturing apparatus according to claim 27, wherein
the obtaining unit obtains the mode information by using at least one of an IC tag, RFID, or Bluetooth.

31. The image capturing apparatus according to claim 27, wherein
the obtaining unit obtains the mode information based on access point information.

32. The image capturing apparatus according to claim 27, further comprising:
a storage unit configured to store a mode to which the switching unit has switched; and
a control unit, in a case where the first mode is stored in the storage unit, that performs control such that the obtaining unit obtains the mode information.

33. The image capturing apparatus according to claim 27, further comprising:
a display control unit that displays, on a display unit, the second identification information before the second identification information is transmitted to the control apparatus,
wherein in a case where an instruction to transmit the second identification information displayed on display to the control apparatus has been given, the transmission unit transmits the second identification information to the control apparatus.

34. The image capturing apparatus according to claim 27, wherein
in at least one of a case where access point information has been changed, a case where Global Positioning System (GPS)-based position information has been changed, a case where a predetermined time has elapsed from when a specific operation was performed, a case of login, or a case where a specific operation has been performed, the obtaining unit obtains the mode information.

35. The image capturing apparatus according to claim 27, further comprising:
an operation unit that instructs switching between the first mode and the second mode,
wherein in a case where the operation unit instructs switching, the switching unit switches the mode regardless of the mode information.

36. The image capturing apparatus according to claim 27, wherein
the information on the management target includes patient information or photographer information.

37. A method of controlling an image capturing apparatus, the method comprising:
obtaining mode information;
based on the mode information, switching between a first mode in which first identification information indicating a management target is transmitted to a control apparatus and a second mode in which second identification information indicating at least one of a terminal apparatus on which information on the management target can be viewed and an application activated on the terminal apparatus and for viewing the information on the management target is transmitted to the control apparatus;
in a case of the first mode, transmitting the first identification information to a control apparatus connected via a communication unit and, in a case of the second mode, transmitting the second identification information to the control apparatus;
receiving, from the control apparatus, information on a management target corresponding to the first identification information or the second identification information; and
attaching the information on the management target to image data of the image captured by the image capturing unit.

38. A non-transitory computer-readable storage medium storing a program that causes a computer to execute a control method, the control method comprising:
obtaining, from an image capturing apparatus connected via a communication unit, first identification information of the image capturing apparatus, and information obtained by the image capturing apparatus and related to second identification information of at least one of a terminal apparatus on which information on a management target can be viewed and an application activated on the terminal apparatus and for viewing the information on the management target;
obtaining, from a management apparatus of the management target via the communication unit, the information on the management target corresponding to the second identification information;
storing first identification information and the second identification information in association with each other; and
in a case where the information on the management target being viewed in the terminal apparatus corresponding to the second identification information has been changed, performing control to transmit, to the image capturing apparatus associated with the second identification information, the information on the management target corresponding to the second identification information that has been newly obtained from the management apparatus.

39. A non-transitory computer-readable storage medium storing a program that causes a computer to execute a method of controlling an image capture apparatus, the method comprising:
obtaining information related to first identification information of at least one of a terminal apparatus on which information on a management target can be viewed and an application activated on the terminal apparatus and for viewing information on a management target;
transmitting, to a control apparatus connected via a communication unit, the information related to the first identification information and second identification information of an image capturing apparatus;
receiving, from the control apparatus, information on a management target corresponding to the first identification information; and
attaching the information on the management target to image data of an image captured by an image capturing unit provided within the image capturing apparatus.

40. A non-transitory computer-readable storage medium storing a program that causes a computer to execute a method of controlling an image capture apparatus, the method comprising:
obtaining mode information;
switching, based on the mode information, that switches between a first mode in which first identification information indicating a management target is transmitted to a control apparatus and a second mode in which second identification information indicating at least one of a terminal apparatus on which information on the management target can be viewed and an application activated on the terminal apparatus and for viewing the information on the management target is transmitted to the control apparatus;
transmitting, in a case of the first mode, that transmits the first identification information to a control apparatus connected via a communication unit and, in a case of the second mode, transmits the second identification information to the control apparatus;
receiving, from the control apparatus, information on a management target corresponding to the first identification information or the second identification information; and
attaching the information on the management target to image data of an image captured by an image capturing unit provided within the image capturing apparatus.
